(19) United States
(12) Patent Application Publication
(10) Pub. No.: US 2026/0352276 A1
(43) Pub. Date: Nov. 5, 2026

(54) DEVICE AND METHOD FOR DEEP LEARNING BASED CHANNEL STATE INFORMATION FEEDBACK FOR WIRELESS LAN

(71) Applicant: SAMSUNG ELECTRONICS CO., LTD., Suwon-si (KR)

(72) Inventors: Eun Sung JEON, Suwon-si (KR); Yoseb JEON, Pohang-si (KR); Junyong SHIN, Pohang-si (KR); Inhyoung KIM, Suwon-si (KR)

(73) Assignee: SAMSUNG ELECTRONICS CO., LTD., Suwon-si (KR)

(21) Appl. No.: 19/657,461

(22) Filed: Apr. 24, 2026

(30) Foreign Application Priority Data
Apr. 24, 2025 (KR) 10-2025-0054122

(51) Int. Cl. H04B 7/06; G06N 3/08; H04L 25/02; H04L 41/16

(52) U.S. Cl. CPC H04B 7/0617; G06N 3/08; H04B 7/0626; H04L 25/0202; H04L 41/16

(57) ABSTRACT

According to an embodiment, a method of communication between a first device and a second device in a wireless communication system comprising the first device and the second device, the method being executed by at least one processor of the first device, and the method comprising: receiving, from the second device, a Null Data Packet (NDP); generating a plurality of channel information associated with a plurality of subcarriers based on the NDP; generating a plurality of angle information based on the plurality of channel information; encoding the plurality of angle information to generate a latent vector; dividing the latent vector into N preset sub-vectors and vector-quantizing each of the N preset sub-vectors based on a codebook size; and transmitting, to the second device, a beamforming feedback including N quantized sub-vectors.

### CROSS-REFERENCE TO RELATED APPLICATION

This application claims priority to and the benefit of Korean Patent Application No. 10-2025-0054122 filed with the Korean Patent Office on Apr. 24, 2025, the entire contents of which are incorporated herein by reference.

### BACKGROUND

### 1. Field

The present disclosure relates to a wireless communication method and a wireless communication device in a wireless communication system. Specifically, the present disclosure relates to a method for performing efficient channel state information feedback based on machine learning in a Wireless Local Area Network, (WLAN) environment.

### 2. Background

In a WLAN system, a method is used in which a station (STA) feeds back channel status information (CSI) to an access point AP to improve beamforming performance. In particular, with the introduction of joint beamforming technology in which the plurality of APs cooperate in the IEEE 802.11bn standard, high-precision CSI feedback is essential. However, while processing and transmitting high-dimensional CSI, computational complexity increases, causing the size of feedback data to become large, and causing a decrease in system throughput.

To solve this problem, a CSI compression and reconstruction method using artificial intelligence/machine learning (AI/ML) technology are being proposed. Although technology to reduce the amount of transmission data using an Auto Encoder-based neural network is being researched, even in such research, a significant amount of CSI feedback overhead may occur. An excessive amount of feedback overhead may lead to degradation in the throughput of the entire system. Therefore, the development of a technology that enables accurate CSI reconstruction while reducing feedback overhead is required.

### SUMMARY

A wireless communication method and a wireless communication device according to an embodiment are for reducing feedback overhead. A wireless communication method and a wireless communication device according to an embodiment are for improving reconstruction performance.

According to an embodiment, a method of communication between a first device and a second device in a wireless communication system comprising the first device and the second device, the method being executed by at least one processor of the first device, and the method comprising: receiving, from the second device, a Null Data Packet (NDP); generating a plurality of channel information associated with a plurality of subcarriers based on the NDP; generating a plurality of angle information based on the plurality of channel information; encoding the plurality of angle information to generate a latent vector; dividing the latent vector into N preset sub-vectors and vector-quantizing each of the N preset sub-vectors based on a codebook size; and transmitting, to the second device, a beamforming feedback including N quantized sub-vectors.

According to an embodiment, a method of communication between a first device and a second device in a Wireless Local Area Network (WLAN) system comprising the first device and the second device, the method being executed by at least one processor of the second device, the method comprising: receiving, from the first device, feedback information and a feedback indicator that indicates information about a sub-vector within the feedback information, and the feedback information comprising angle information; determining whether the feedback indicator is 1; based on determining that the feedback indicator is 1, decoding the angle information to generate a first decoding output; beamforming based on the first decoding output.

According to an embodiment, a first device configured to communicate with a second device in a wireless communication system, the first device comprising: a channel estimator configured to estimate a channels corresponding to a plurality of subcarriers based on a null data packet (NDP) received from the second device; and a beamforming feedback generator configured to encode a plurality of channel information to: generate a latent vector, divide the latent vector into N preset sub-vectors, vector-quantize each of the N preset sub-vectors based on a codebook size, and generate beamforming feedback including the N quantized sub-vectors.

### BRIEF DESCRIPTION OF DRAWINGS

FIG. 1 is a block diagram illustrating a wireless communication system according to an embodiment.

FIG. 2 is a diagram illustrating an operation method of a wireless communication system according to an embodiment.

FIG. 3 is a block diagram illustrating a wireless communication system according to an embodiment.

FIG. 4 is a diagram illustrating a beamformer according to an embodiment.

FIG. 5 is a diagram illustrating an encoder according to FIG. 4.

FIG. 6 is a diagram illustrating a potential vector according to an embodiment.

FIG. 7 is a diagram illustrating a beamformer according to an embodiment.

FIG. 8 is a diagram illustrating a decoder according to FIG. 7.

FIG. 9 is a diagram illustrating a beamformee according to an embodiment.

FIG. 10 is a diagram illustrating a beamformer according to an embodiment.

FIG. 11 is a diagram illustrating a beamformer according to an embodiment.

FIG. 12 is a diagram illustrating a beamformer according to an embodiment.

FIG. 13 is a flowchart illustrating an operation method of a wireless communication system according to an embodiment.

FIG. 14 is a flowchart illustrating an operation method of a wireless communication system according to an embodiment.

FIG. 15 is a flowchart illustrating an operation method of a wireless communication system according to an embodiment.

FIG. 16 is a graph showing the normalized mean squared error NMSE according to feedback overhead.

FIG. 17 is a graph illustrating NSME according to feedback overhead.

FIG. 18 is a graph illustrating NSME according to feedback overhead.

FIG. 19 is a table illustrating the complexity of the beamformer structure according to FIG. 18.

FIG. 20 is a graph illustrating NSME according to feedback overhead.

FIG. 21 is a table showing the net throughput of a wireless communication system according to a prior art and an embodiment.

FIG. 22 is a block diagram illustrating an application processor according to an embodiment.

FIG. 23 is a block diagram of a wireless communication device according to an embodiment.

### DETAILED DESCRIPTION

Hereinafter, embodiments of the present invention will be described in detail with reference to the accompanying drawings so that a person having ordinary skill in the art to which the present invention pertains can easily implement them. However, the present invention can be implemented in various different forms and is not limited to the embodiments described herein.

And in the drawings, parts unrelated to the description have been omitted to clearly describe the present invention, and similar reference numerals have been attached to similar parts throughout the specification. In the flowcharts described with reference to the drawings, the order of operations may be changed, several operations may be merged, a certain operation may be divided, and a specific operation may not be performed.

In addition, a representation described in the singular can be interpreted as singular or plural, unless an explicit expression such as “one” or “single” is used. Terms including ordinals such as first, second, etc., may be used to describe various constituent elements, but the constituent elements are not limited by these terms. These terms may be used for the purpose of distinguishing one constituent element from another.

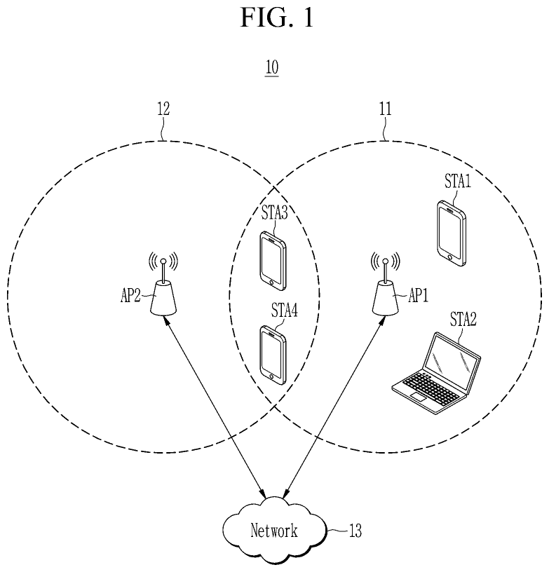

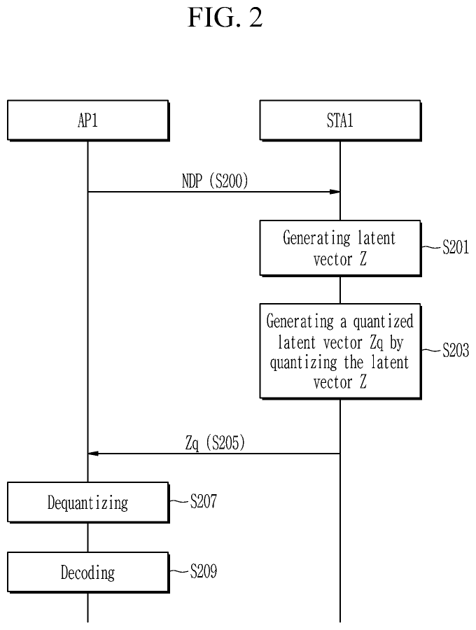

FIG. 1 is a block diagram illustrating a wireless communication system according to an embodiment. FIG. 2 is a diagram illustrating an operation method of a wireless communication system according to an embodiment.

FIG. 1 illustrates a wireless local area network (WLAN) system, which is an example of a wireless communication system 10.

Hereinafter, in describing embodiments of the present disclosure in detail, a wireless communication system based on orthogonal frequency-division multiplexing OFDM or orthogonal frequency division the plurality of access OFDMA, particularly the IEEE 802.11 standard, will be the main subject. However, the present invention is not limited thereto and may be applied to various communication systems having similar technical backgrounds and channel forms. For example, it may be applied to cellular communication systems such as long term evolution (LTE), LTE-advanced (LTE-A), new radio (NR), wireless broadband (WiBro), global system for mobile communication (GSM), or near field communication systems such as Bluetooth, near field communication (NFC).

In the various embodiments of the present disclosure described below, a hardware approach is described as an example. However, since various embodiments of the present disclosure include techniques using both hardware and software, various embodiments of the present disclosure do not exclude software-based approaches.

Referring to FIG. 1, a wireless communication system 10 may include first and second access points AP1, AP2, a first station STA1, a second station STA2, a third station STA3, and a fourth station STA4.

The first access point AP1 and the second access point AP2 may communicate with a network 13 including the Internet, an IP (internet protocol) network, or any other arbitrary network. A first access point AP1 may provide access to network 13 to a first station STA1, a second station STA2, a third station STA3, and a fourth station STA4 within a first coverage area 11. A second access point AP2 may provide access to network 13 to a third station STA3 and a fourth station STA4 within a second coverage area 12. In an embodiment, a first access point AP1 and a second access point AP2 may communicate with at least one of a first station STA1, a second station STA2, a third station STA3, and a fourth station STA4 based on wireless fidelity WiFi or any other WLAN connection technology.

The first coverage area 11 and the second coverage area 13 are illustrated as circular, but the present invention is not limited thereto. The first coverage area 11 and the second coverage area 13 may have other shapes reflecting various changes in a wireless environment related to natural or artificial obstructions, or may have other shapes including irregular shapes depending on the settings of the first access point AP1 and the second access point AP2.

Depending on the network type, the access point may be referred to as a router, a gateway, etc. In a WLAN system, an access point may be provided for a wireless channel. An access point may be identified as a station to other access points depending on its operation. In an embodiment, an access point may also be referred to as a device, a wireless device, a communication device, or the like.

Depending on the network type, a station may be referred to as a mobile station, a subscriber station, a terminal, a mobile terminal, a wireless terminal, user equipment, or a user. A station may be a portable device, such as a mobile phone, a laptop computer, a wearable device, or a stationary device, such as a desktop computer, a smart TV, etc. A station may represent a remote wireless device that wirelessly connects to an access point or connects to a wireless channel within a WLAN. A station may be identified as an access point to other stations depending on its operation. In this specification, a station may be referred to as a first device, and an access point may be referred to as a second device. An access point AP1, AP2 may allocate at least one resource unit RU to at least one station STA1~STA4.

An access point AP1, AP2 may transmit data through at least one allocated resource unit, and at least one station may receive data through at least one allocated resource unit.

In 802.11ax, an access point AP1, AP2 may allocate only a single resource unit to at least one station, while in 802.11be (hereinafter, EHT) or the next-generation IEEE 802.11 standards (hereinafter, EHT+), an access point AP1, AP2 may allocate a multi-resource unit MRU including two or more resource units to at least one station. For example, a first access point AP1 may allocate a multi-resource unit to at least one of a first station STA1, a second station STA2, a third station STA3, and a fourth station STA4, and transmit data through the allocated multi-resource unit.

Access points AP1, AP2 may communicate with at least one station STA1~STA4 using beamforming techniques. For example, single-user beamforming may improve reception performance of a single user, and multi-user beamforming may improve overall reception performance of the plurality of users by eliminating interference between the plurality of users.

Access points AP1, AP2 and stations STA1~STA4 may perform channel sounding for beamforming, and the channel sounding may be based on a sounding protocol. As described below with reference to the drawings, access points AP1, AP2 may efficiently perform channel sounding with stations STA1 to STA4 supporting various protocol standards (e.g., EHT, EHT+, etc.).

Referring to FIG. 2 together, the first access point AP1 may transmit a null data packet NDP to the first station STA1 in operation S200. NDP may be based on a predetermined protocol standard but is not limited thereto.

Thereafter, the first station STA1 may generate a latent vector z based on the NDP in operation S201.

For example, the first station STA1 may use the received NDP to generate a plurality of channel information corresponding to a plurality of subcarriers. The plurality of subcarriers may be subcarriers selected by the first access point AP1 to provide channel-related feedback to the first station STA1. The first access point AP1 may provide information indicating the plurality of subcarriers to the first station STA1 in advance. For example, the first station STA1 may perform singular value decomposition on the estimated channels to generate the plurality of beam steering matrices corresponding to the plurality of subcarriers. The first station STA1 may generate a plurality of angle information corresponding to a plurality of subcarriers from a plurality of beam steering matrices. The first station STA1 may generate a latent vector z using the generated plurality of angle information.

The first station STA1 may quantize the latent vector z to generate a quantized latent vector Zq in operation S203.

For example, the first station STA1 may divide the latent vector z into N sub-vectors of D dimension. The first station STA1 may quantize each of the N sub-vectors to a bit size corresponding to the codebook size to generate a plurality of quantized latent vectors Zq. In an embodiment, the codebook size may be set by the first access point AP1, and the first access point AP1 may provide information indicating the codebook size to the first station STA1. For example, the codebook size may be set based on the training results of the first station STA1 and the first access point AP1.

The first station STA1 may transmit the quantized latent vector Zq to the first access point AP1 in operation S205.

The first access point AP1 may dequantize the quantized latent vector Zq in operation S207.

Thereafter, the first access point AP1 may decode the dequantized latent vector in operation S209.

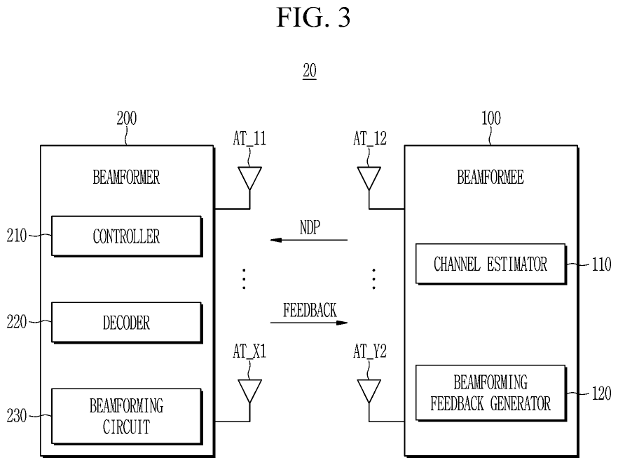

FIG. 3 is a block diagram illustrating a wireless communication system according to an embodiment.

A wireless communication system 20 may include a beamformer 200 and a beamformee 100 that communicate with each other. The beamformee 100 and beamformer 200 may be any device that communicates in a wireless communication system 20 and may be a device for wireless communication. In an embodiment, the beamformee 100 may be a station (or first device) of a WLAN system, and the beamformer 200 may be an access point (or second device).

The beamformee 100 may include a channel estimator 110, a beamforming feedback generator 120, and a plurality of second antennas AT_12~AT_Y2. In an embodiment, a channel estimator 110 and a beamforming feedback generator 120 may constitute the processing circuit of a beamformee 100.

The beamformee 100 may receive NDP from the beamformer 200 through a plurality of second antennas AT_12~AT_Y2. The Beamformee 100 may generate first feedback information or second feedback information based on NDP. The beamformee 100 may transmit first feedback information or second feedback information to the beamformer 200.

The channel estimator 110 may estimate channels for the plurality of subcarriers based on a reference signal included in the received NDP. In an embodiment, an NDP may also be referred to as a sounding packet.

The channel estimator 110 may generate channel state information based on the estimated channel. The channel state information may include at least one of a channel quality indicator CQI, a precoding matrix indicator PMI, and a rank indicator RI.

For example, when a beamformer 200 having Nₜ transmit antennas transmits information to a beamformee 100 having Nᵣ receive antennas using orthogonal frequency-division multiplexing OFDM with N_{c} subcarriers, the channel matrix may be represented by Equation 1.

H[k]∈C^{N}^{ᵣ}^{×N}^{ₜ},(k=1, . . . ,N_{c}) Equation 1

The beamforming feedback generator 120 may perform singular value decomposition on the channels H[k] estimated from the channel estimator 110. The singular value decomposition channel matrix may be represented by Equation 2.

H[k]=U[k]∈[k]\tilde{V}^{H}[k] Equation 2

Here, \tilde{V}[k]∈C^{N}^{ₜ}^{×N}^{ₜ} is the right singular matrix of H[k], and may include Hermitian operators. Also, \tilde{V}[k] may be a beamforming matrix of the beamformer 200. Uₖ may be a left singular matrix. Uₖ may be a diagonal matrix containing non-negative singular values.

The size of the left singular matrix Uₖ may be Nr×Nr. The size of the right singular matrix \tilde{V}[k] may be Nt×Nt. Also, the size of Σ[k] may be Nr×Nt.

In a wireless communication system 20 according to some embodiments (e.g., an IEEE 802.11n/ac/ax WLAN system), a beamformer 200 transmits a signal to a beamformee 100 through OFDM (Orthogonal Frequency Division Multiplexing) modulation in which NFFT subcarriers within one symbol are guaranteed to be orthogonal to each other, so the channel estimation operation of the channel estimator 110 and the singular value decomposition operation of the beamforming feedback generator 120 may be performed for each subcarrier.

Meanwhile, the beamforming feedback generator 120, in order to reduce the feedback overhead transmitted to the beamformer 200, may not transmit the beam steering matrix \tilde{V}^{H}[k] as is to the beamformer 200, but may extract only Nₛ columns, which is the current number of transmission streams, to construct V̅[k]∈C^{N}^{ₜ}^{×N}^{ₛ}. After that, a diagonal matrix D for performing a common phase shift can be applied so that the last row of V̅[k] is composed of real numbers with non-negative values, which may be represented by the equation 3.

V[k]=V̅[k]Ď*[k] Equation 3

Here, \tilde{D}[k]∈C^{N}^{ₜ}^{×N}^{ₜ} is a diagonal matrix, the diagonal elements of matrix are composed of the phase coefficients of the last row of V̅[k]. Also, using the property that all columns of V[k] are composed of unit orthogonal vectors and the last row is composed of real numbers with non-negative values, the beamforming feedback generator 120 may decompose V[k] into angular parameters through a givens rotation matrix. This may be represented by equation 4.

$$V [ k ] = ( {\prod }_{i = 1}^{min ( {N}_{s} , {N}_{t} - 1 )} ( {D}_{i} ( {ϕ}_{i}^{( k )} ) {\prod }_{l = i + 1}^{{N}_{t}} {G}_{li}^{T} ( {ψ}_{li}^{( k )} ) ) ) {I}_{{N}_{t} \times {N}_{s}} \qquad Equation 4$$

Here, Dᵢ(φᵢ) may be a Nₜ×Nₜ diagonal matrix defined by equation 5 below.

$${D}_{i} ( {ϕ}_{i} ) = [ \begin{matrix}{I}_{i - 1} & 0 & 0 & 0 & 0 \\ 0 & {e}^{j {ϕ}_{i , i}} & 0 & ⋯ & 0 \\ 0 & 0 & ⋱ & ⋯ & 0 \\ 0 & 0 & ⋯ & {e}^{j {ϕ}_{{N}_{t} - 1 , i}} & 0 \\ 0 & 0 & ⋯ & 0 & 1\end{matrix} ] \qquad Equation 5$$

Additionally, Gₗᵢ(ψₗᵢ) may be a Nₜ×Nₜ Givens rotation matrix defined by equation 6.

$${G}_{li} ( {ψ}_{li} ) = [ \begin{matrix}{I}_{i - 1} & 0 & 0 & 0 & 0 \\ 0 & cos {ψ}_{li} & 0 & sin {ψ}_{li} & 0 \\ 0 & 0 & {I}_{l - i - 1} & 0 & 0 \\ 0 & - sin {ψ}_{li} & 0 & cos {ψ}_{li} & 0 \\ 0 & 0 & 0 & 0 & {I}_{{N}_{t} - l}\end{matrix} ] \qquad Equation 6$$

That is, the beamforming feedback generator 120 may generate angle information ψ, φ representing phase and magnitude from beam steering matrices \tilde{V}[k] of a plurality of subcarriers based on Equation 3 to Equation 6. This may be represented by equation 7.

$$\text{?} ∈ \{ \frac{n π}{{2}^{{b}_{ϕ} - 1}} + \frac{π}{{2}^{{b}_{ϕ}}} \vert n = 1 , 2 , … , {2}^{{b}_{ϕ} - 1} \} \qquad Equation 7$$

$$\text{?} ∈ \{ \frac{n π}{{2}^{{b}_{ψ} + 1}} + \frac{π}{{2}^{{b}_{ϕ} + 2}} \vert n = 1 , 2 , … , {2}^{{b}_{ψ} - 1} \}$$

ψ represents the size of the beam steering matrix Vₖ, and φ may represent the phase of the beam steering matrix Vₖ. The first beamforming feedback generator 120 may quantize each parameter using b_{φ} and b_{ψ} bits. For example, the beamforming feedback generator 120 may quantize the first angle to a bit size of b_{φ} and may quantize the second angle to a bit size of b_{ψ}. Here, [symbol] is the quantized first angle and [symbol] is the quantized second angle.

Meanwhile, when the number of beamformers 200 increases and the plurality of first antennas AT_11 to AT_X1 are used or a wide bandwidth (e.g., 320 MHz) is applied, excessive overhead of feedback information may occur. Accordingly, the beamforming feedback generator 120 may compress the quantized angular parameters into a low-dimensional latent vector through an auto-encoder based on an artificial neural network.

For example, the beamforming feedback generator 120 may list the angular parameters for some of the extracted N_{c} subcarriers in the form of equation 8.

Φ∈R^{2×N}^{ₚ}^{×N}^{_{c}} Equation 8

Here, the number of angular parameters extracted from each subcarrier is Nₚ, which may be represented by equation 9.

$${N}_{p} = max ( {\sum }_{i = max ( {N}_{t} - {N}_{s} , 1 )}^{{N}_{t} - 1} i , 2 ) \qquad Equation 9$$

The beamforming feedback generator 120 may input an angular parameter Φ to the encoder. This may be represented by equation 10.

z=f_{enc}(Φ) Equation 10

In an embodiment, the beamforming feedback generator 120 may convert the latent vector z into a finite bit string by vector quantization VQ. The beamforming feedback generator 120 may transmit a latent vector z_{q} quantized into a finite bit string to the beamformer 200. The beamforming feedback generator 120 may divide the latent vector z into N sub-vectors of dimension D. D can be preset by the number of channels. This may be represented by equation 11.

M=N×D Equation 11

Here, zᵢ is zᵢ=[z_{(i-1)D+1}, . . . , z_{iD}] as the ith sub-vector of z, and zⱼ is corresponds to the jth element of z. The beamforming feedback generator 120 may individually quantize each sub-vector using a D dimension vector quantization codebook. For example, the beamforming feedback generator 120 may receive a codebook from the beamformer 200 according to the current protocol standard. In an embodiment, the codebook size may be set by the beamformee 100, and the beamformee 100 may provide information indicating the codebook size to the beamformer 200. For example, the codebook size may be set based on the training results of the beamformer 200 and the beamformee 100.

In an embodiment, the beamforming feedback generator 120 may use a minimum Euclidean distance criterion to quantize each sub-vector. This may be represented by equation 12.

$${z}_{q , i} = arg {min}_{{b}_{k} ∈ ℬ} {‖ {z}_{i} - {b}_{k} ‖}^{2} \qquad Equation 12$$

The beamforming feedback generator 120 may combine each quantized sub-vector and transmit the combined bit string z_{q}=[z_{q,1}, . . . , z_{q,N}] as first feedback information to the beamformer 200. Here, [symbol] is a codebook of dimension D, which may contain a total of 2^{B} codewords {bₖ} (k=1, . . . , 2^{B}) using B bits.

Meanwhile, the beamforming feedback generator 120 may calculate the difference between the current angle parameter and the previous angle parameter, and may also use the difference in angle parameters as input to the encoder. The difference

$${Φ}_{t}^{diff}$$

between the angle parameter Φₜ at time t and the angle parameter Φₜ₋₁ at the previous time t−1 may be represented by equation 13.

$${Φ}_{t}^{diff} = {Φ}_{t} - {Φ}_{t - 1} \qquad Equation 13$$

Here, the beamforming feedback generator 120 may perform preprocessing on the difference in angular parameters

$${Φ}_{t}^{diff}$$

by reflecting the periodicity of the angular difference. The preprocessing function is h(x), which may be represented by equation 14.

$$h ( x ) = \{ \begin{matrix}x , & if \vert x \vert < π \\ - sgn ( x ) \times ( 2 π - \vert x \vert ) , & otherwise\end{matrix} \qquad Equation 14$$

Here, sgn(·) is a function that returns the sign of the input value, and may return 1 when the input value is positive, −1 when it is negative, and 0 when it is 0. The beamforming feedback generator 120 may consider only one direction of rotation when calculating the angular difference

$${Φ}_{t}^{diff}$$

using the preprocessing function h(x). Accordingly,

$${Φ}_{t}^{diff}$$

may be determined as the minimum rotation whose absolute value is always less than x, and may determine the minimum rotation that ensures a more effective input for considering the temporal correlation of the angular parameters.

The beamforming feedback generator 120 may determine the angular parameter as an input to the encoder when the preprocessed angular difference is greater than a preset threshold (i.e., when the temporal correlation is low). Additionally, the beamforming feedback generator 120 may determine the difference in angular parameters as an input to the encoder when the preprocessed angular difference is less than a preset threshold (i.e., when the temporal correlation is high). This may be represented by equation 15.

$${N}_{d , t} = {\sum }_{m , n} \text{?} ( \vert h ( {[ {Φ}_{t}^{diff} ]}_{m , n} ) \vert > {μ}_{th} ) \qquad Equation 15$$

Here, μₜₕ may be a preset threshold to determine whether a value

$${Φ}_{t}^{diff}$$

is considered 0. I(·) may be an indicator function that returns 1 if the input condition is true, and 0 otherwise. The beamforming feedback generator 120 may determine that the difference of the angular parameters is sufficiently sparse if the number of non-zero elements N_{d,t} at time t is less than a threshold Nₜₕ (Nₜₕ<2*NₚN_{c}), and may determine the difference in the angular parameters as an input to the encoder. The beamforming feedback generator 120 may determine the input of the encoder based on equation 16.

Iₜ=I(N_{d,t}<Nₜₕ) Equation 16

The indicator variable Iₜ is a function to determine whether the difference of the angular parameter is sparse. The indicator variable Iₜ may be set to 1 if the angular difference feedback is selected, and 0 otherwise. 1 additional bit is required to indicate whether the difference of the angular parameter is sparse. However, this additional overhead is only 1 bit, so its impact is minimal compared to the overall CSI feedback overhead.

Thereafter, the beamforming feedback generator 120 may input the difference in angular parameters Φ to the encoder. This may be represented by equation 17.

$${z}^{′} = {f}_{enc} ( {Φ}_{t}^{diff} ) \qquad Equation 17$$

The beamforming feedback generator 120 may combine each quantized sub-vector z′_{q,i} and transmit the combined bit string z′_{q}=[z_{q,1}, . . . , z_{q,N}] as second feedback information to the beamformer 200. Here, [symbol] is a codebook of dimension D, which may contain a total 2^{B} of codewords {bₖ} (k=1, . . . , 2^{B}) using bits B.

Here, z′ᵢ is z′ᵢ=[z_{(i-1)D+1}, . . . , z_{iD}] as the ith sub-vector of z′, and zⱼ is corresponds to the j th element of z. The beamforming feedback generator 120 may individually quantize each sub-vector using a D dimension vector quantization codebook. In an embodiment, the beamforming feedback generator 120 may use a minimum Euclidean distance criterion to quantize each sub-vector. This may be represented by equation 18.

$${z}_{q , i}^{′} = arg {min}_{{b}_{k} ∈ ℬ} {‖ {z}_{i} - {b}_{k} ‖}^{2} \qquad Equation 18$$

The beamforming feedback generator 120 may combine each quantized sub-vector z′_{q,i} and transmit the combined bit string z′_{q}=[z_{q,1}, . . . , z_{q,N}] as second feedback information to the beamformer 200. Here, [symbol] is a codebook of dimension D, which may contain a total 2^{B} of codewords {bₖ} (k=1, . . . , 2^{B}) using bits B.

The beamformer 200 may include a controller 210, a decoder 220, a beamforming circuit 230, and a plurality of first antennas AT_11~AT_X1.

In an embodiment, the controller 210, the decoder 220, and the beamforming circuit 230 may constitute the processing circuit of the beamformer 200.

The beamformer 200 may receive beamforming feedback from the beamformee 100 through a plurality of first antennas AT_11~AT_X1 and a transmitter.

The controller 210 may control all operations for communication of the beamformer 200. The controller 210 may generate a Null Data Packet Announcement NDPA frame and an NDP.

The decoder 220 may process information included in the beamforming feedback so that the beamforming circuit 230 may utilize it. In an embodiment, the decoder 220 may perform decoding on a plurality of channel information extracted from beamforming feedback and perform post-processing on the decoded plurality of channel information. The decoder 220 may decode the plurality of channel information using an autoencoder-based decoder. Thereafter, the decoder 220 may post-process decoded the plurality of channel information based on binary information extracted by the post-processing function and beamforming feedback.

For example, the beamformer 200 may receive a quantized latent vector z_{q} as first feedback information. The decoder 210 may decode the latent vector z_{q} to reconstruct the angle parameter. This may be represented by equation 19.

\hat{Φ}=f_{dec}(z_{q}) Equation 19

Here, \hat{Φ} is a matrix representing the reconstructed angular parameters, and f_{dec} represents the decoder network.

Meanwhile, the beamformer 200 may also receive a quantized latent vector z′_{q} as second feedback information. The decoder 210 may decode the latent vector z′_{q} to reconstruct the angular difference parameter.

The beamforming circuit 230 may perform beamforming based on post-processed the plurality of channel information provided from the decoder 220.

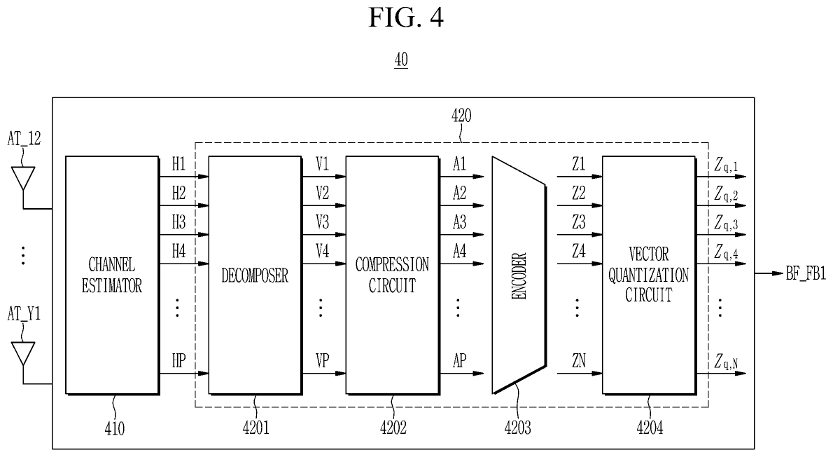

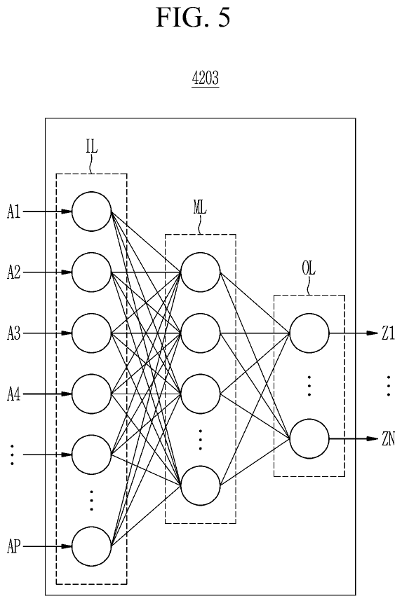

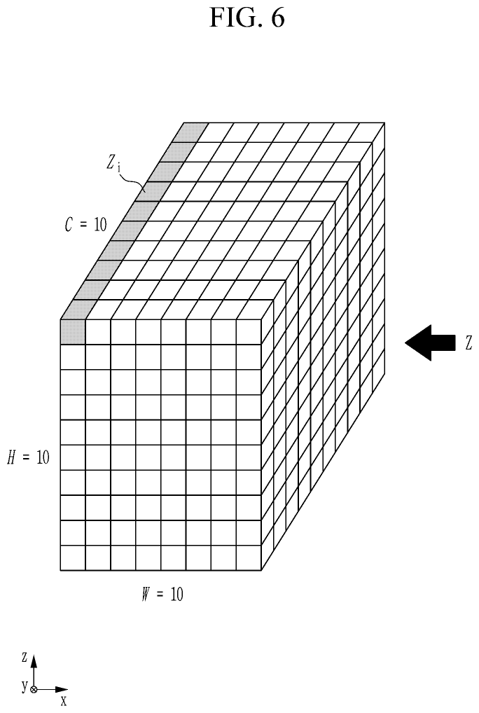

FIG. 4 is a drawing specifically illustrating a beamformer according to an embodiment. FIG. 5 is a diagram illustrating an encoder according to FIG. 4. FIG. 6 is a diagram illustrating a potential vector according to an embodiment.

In FIG. 4, it is described assuming that the plurality of channel information preprocessed and encoded corresponds to the plurality of angle information and/or the plurality of angle difference information, and that the number of streams per subcarrier is one, but the present invention is not limited thereto.

Referring to FIG. 4, the beamformer 40 may include a plurality of second antennas AT_12~AT_Y2, a channel estimator 410, and a beamforming feedback generator 420. The beamforming feedback generator 420 may include a decomposer 4201, a compression circuit 4202, an encoder 4203, and a vector quantization circuit 4204.

The channel estimator 410 may estimate first to Pth channels corresponding to the first to Pth subcarriers to generate a plurality of channel information H1~HP. The channel estimator 410 may provide the plurality of channel information H1 to HP to the decomposer 4201. Here, P is the size of the channel information, which may be the number of subcarriers over which the channel is estimated and/or the number of subcarriers over which the channel information is transmitted. That is, the estimated channel may be estimated for each of the K subcarriers. The decomposer 4201 may generate first to Pth beam steering matrices V1~VP corresponding to first to Pth subcarriers through singular value decomposition of the plurality of channel information H1~HP and provide the same to the compression circuit 4202. The compression circuit 4202 may generate first to P-th angle information A1~AP based on the first to P-th beam steering matrices V1~VP.

The encoder 4203 may encode angle information A1~AP to generate first to Nth latent vectors Z1~ZN. In an embodiment, the encoder 4203 may be configured with an artificial intelligence AI model to encode angular information to reduce the overhead of beamforming feedback. The encoder 4203 may be trained to receive and encode first to Pth angle information A1~AP through machine learning. After training is completed, the encoder 4203 may reduce feedback overhead by encoding and outputting channel information.

Referring to FIG. 5 together, the encoder 4203 may be configured as a neural network including an input layer IL, an intermediate layer ML, and an output layer OL. In FIG. 5, for convenience of explanation, an encoder 4203 having one intermediate layer ML is illustrated, but the present invention is not limited thereto, and a plurality of intermediate layers ML may be configured.

When the number of nodes in the input layer IL is P, the size of the input layer IL is defined as P. Therefore, the number of data input to the input layer IL is also P.

The number of nodes included in the intermediate layer ML and the output layer OL may be configured in various ways. When the number of nodes included in the output layer OL is N, the number of first to Nth latent vectors Z1~ZN, which are encoded angle information output through the encoder 350, is N.

Referring again to FIG. 4, the vector quantization circuit 4204 may generate first feedback information BF_FB1 based on the first to Nth latent vectors Z1~ZN. The vector quantization circuit 4204 may divide the first to Nth latent vectors Z1~ZN into N sub-vectors of dimension D.

FIG. 6 is a diagram illustrating the latent vector z generated by the encoder 4203 in the form of a channel tensor. Here, the x-axis may be the frequency axis, the y-axis may be the channel axis, and the z-axis may be the time axis. The vector quantization circuit 4204 may divide the latent vector z into 80 sub-vectors each having 10 dimensions based on the number of channels.

Thereafter, the vector quantization circuit 4204 may individually quantize each sub-vector zᵢ. In an embodiment, the vector quantization circuit 4204 may individually quantize each of the N sub-vectors using a codebook of dimension D to generate quantized sub-vectors z_{q,1}~z_{q,N}. For example, the vector quantization circuit 4204 may use the minimum Euclidean distance criterion to select the closest value to each sub-vector from among the values stored in the codebook, and quantize each sub-vector using the selected value.

Thereafter, the beamforming feedback generator 420 may generate first feedback information BF_FB1 by combining the quantized sub-vectors z_{q,1}~z_{q,N}.

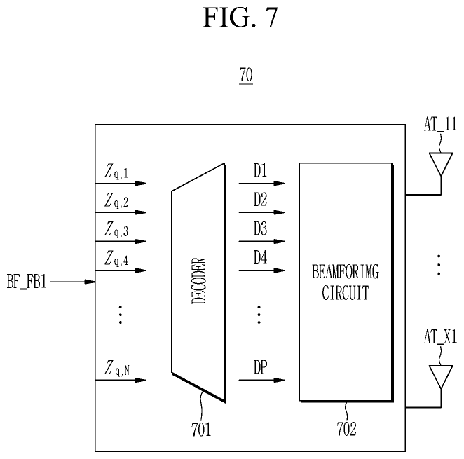

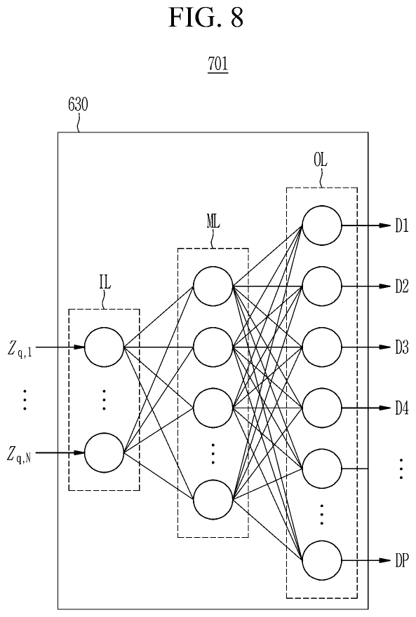

FIG. 7 is a drawing specifically illustrating a beamformer according to an embodiment. FIG. 8 is a diagram illustrating a decoder according to FIG. 7.

As illustrated in FIG. 7, the beamformer 70 may include a decoder 701 and a beamforming circuit 702.

The decoder 701 may decode the sub-vectors z_{q,1}~z_{q,N} included in the first feedback information BF_FB1 and provide M decoded angle information D1~DP to the beamforming circuit 702. The decoder 701 may be configured to decode N encoded channel information z_{q,1}~z_{q,N} included in the first feedback information BF_FB1 received from the beamformee 100. At this time, the encoded channel information~ may be quantized information in the beamformee 100.

Referring to FIG. 8, the decoder 701, like the encoder 4203, may be configured as a neural network including an input layer IL, one or more intermediate layers ML, and an output layer OL. Additionally, the decoder 701 may have a structure that is symmetric with respect to the direction in which nodes are arranged in each layer of the encoder 4203 according to the embodiments described above. That is, the output layer OL of the encoder 4203 may be configured as the input layer IL of the decoder 701, and the input layer IL of the encoder 4203 may be configured as the output layer OL of the decoder 701. Therefore, the size of the input layer IL of the decoder 701 is N, and the size of the output layer OL is P.

The size of each layer may be defined by the number of nodes contained in each layer.

Like the encoder 4203, the decoder 701 may also be trained to decode channel information, which is input data input to the decoder 701, through machine learning. The decoder 701 that has completed training may output P decoded angle information D1~DP by decoding the channel information fed back from the beamformer side as it was originally.

Referring again to FIG. 7, the beamforming circuit 702 may perform beamforming based on the decoded angle information D1~DP.

Meanwhile, the encoder 4203 and the vector quantization circuit 4204 of FIG. 4, and the decoder 701 of FIG. 7 may be trained together based on equation 20.

[symbol]

=d(Φ,\hat{Φ})+∥sg(z)−z_{q}∥²+β∥z−sg(z_{q})∥² Equation 20

Here, d(·,·) is an arbitrary distortion index, and the difference between two input values may be measured using a specific criterion. For example, the mean squared error MSE such as

$$d ( Φ , \hat{Φ} ) = {‖ Φ - \hat{Φ} ‖}_{F}^{2}$$

is used, but the present invention is not limited thereto and any distortion index may be used. Additionally, sg(·) may represent a stop-gradient operator that ignores gradient computation. Additionally, ∥sg(z)−z_{q}∥²+β∥z−sg(z)∥² is to minimize the difference between z and z_{q} depending on quantization loss. Quantization loss may be computed by two terms and hyperparameters β. z_{q}←z+sg(z_{q}−z) After calculating the quantization loss, gradient correction of the decoder input may be performed as z_{q}←z+sg(z_{q}−z).

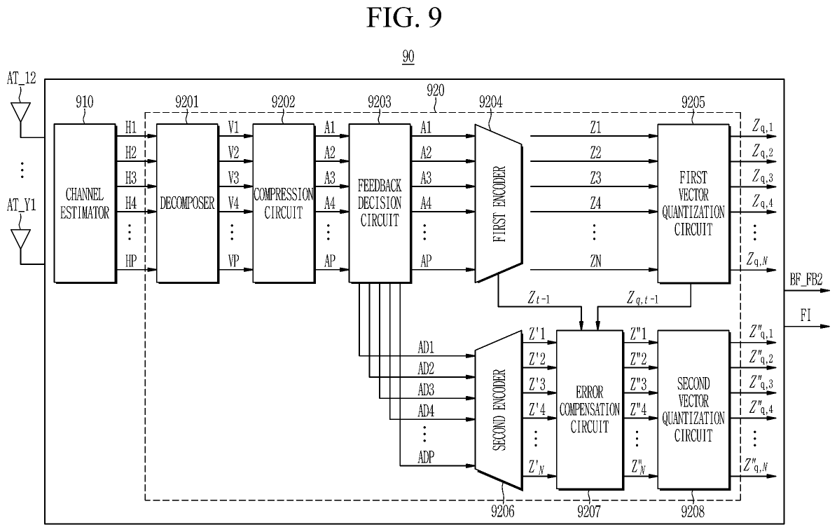

FIG. 9 is a drawing specifically illustrating a beamformer according to an embodiment.

In FIG. 9, it is described assuming that the plurality of channel information preprocessed and encoded corresponds to the plurality of angle information and/or the plurality of angle difference information, and that the number of streams per subcarrier is one, but the present invention is not limited thereto.

Referring to FIG. 9, the beamformer 90 may include a plurality of second antennas AT_12~AT_Y2, a channel estimator 910, and a beamforming feedback generator 920. A beamforming feedback generator 920 may include a decomposer 9201, a compression circuit 9202, a feedback decision circuit 9203, a first encoder 9204, a first vector quantization circuit 9205, a second encoder 9206, an error compensation circuit 9207, and a second vector quantization circuit 9208.

Unless otherwise stated, the description of each of the channel estimator 410, decomposer 4201, and compression circuit 4202 described with reference to FIG. 4 may also be applied to each of the channel estimator 910, decomposer 9201, and compression circuit 9202.

The feedback decision circuit 9203 may generate first to Pth angle difference information AD1~ADP based on first to Pth angle information A1~AP. The feedback decision circuit 9203 may generate first to Pth angle difference information AD1~ADP based on two consecutive angle information among the first to Pth angle information A1~AP. The feedback decision circuit 9203 may transmit the first to P-th angle information A1~AP to the first encoder 9204 based on the first to P-th angle difference information AD1~ADP or transmit the first to P-th angle difference information AD1~ADP to the second encoder 9206.

In an embodiment, the feedback decision circuit 9203 may perform preprocessing on the angular difference

$${Φ}_{t}^{diff}$$

to reflect the periodicity of the angular difference. For example, the feedback decision circuit 9203 may perform preprocessing on the angle difference

$${Φ}_{t}^{diff}$$

based on the preprocessing function h (x) represented by equation 21.

$$h ( x ) = \{ \begin{matrix}x , & if \vert x \vert < π \\ - sgn ( x ) \times ( 2 π - \vert x \vert ) , & otherwise\end{matrix} \qquad Equation 21$$

Here, sgn(·) is a function that returns the sign of the input value, and may return 1 when the input value is positive, −1 when it is negative, and 0 when it is 0. The feedback decision circuit 4203 may only consider one direction of rotation when calculating the angle difference

$${Φ}_{t}^{diff}$$

using the preprocessing function h(x).

The feedback decision circuit 9203 may determine the first encoder 9204 or the second encoder 9206 by comparing the preprocessed angle difference with a preset threshold based on equation 21. This may be represented by equations 22 and 23 below.

$${N}_{d , t} = {\sum }_{m , n} 𝕀 ( \vert h ( {[ {Φ}_{t}^{diff} ]}_{m , n} ) \vert > {μ}_{th} ) \qquad Equation 22$$

Here, μₜₕ may be a preset threshold. I(·) can be an indicator function that returns 1 if the input condition is true, and 0 otherwise.

Iₜ=I(N_{d,t}<Nₜₕ) Equation 23

The indicator variable Iₜ may be a function to determine whether the difference in the angular parameters is sparse. For example, if the preprocessed angle difference exceeds a preset threshold, Iₜ is 0, and the feedback decision circuit 9203 may transmit the first to Pth angle information A1~AP to the first encoder 9204. For example, if the preprocessed angle difference is less than or equal to a preset threshold value, Iₜ is 1, and the feedback decision circuit 9203 may transmit the first to Pth angle difference information AD1~ADP to the second encoder 9206.

The first encoder 9204 may encode the first to Pth angle information A1~AP to generate the first to Nth latent vectors Z1~ZN. In an embodiment, the first encoder 9204 may be configured as an artificial intelligence AI model. The first encoder 9204 may be trained to receive and encode first to Pth angle information A1~AP through machine learning. After training is completed, the first encoder 9204 may reduce feedback overhead by encoding and outputting channel information.

The first vector quantization circuit 9205 may divide the first to Nth latent vectors Z1~ZN into N sub-vectors of dimension D. Thereafter, the vector quantization circuit 4204 may individually quantize each sub-vector zᵢ (i is an integer from 1 to N). In an embodiment, the first vector quantization circuit 9205 may individually quantize each of the N sub-vectors using a codebook of dimension D to generate quantized sub-vectors z_{q,1}~z_{q,N}. For example, the first vector quantization circuit 9205 may use the minimum Euclidean distance criterion to select the closest value to each sub-vector from among the values stored in the codebook, and quantize each sub-vector using the selected value. In an embodiment, the codebook size may be set by the beamformer 90, and the beamformer 90 may provide information indicating the codebook size to the beamformer 200 of FIG. 3. For example, the codebook size may be set based on the training results of the beamformer 200 and the beamformer 90.

The second encoder 9206 may encode the first to Pth angle difference information A1~AP to generate the first′ to N′th latent vectors Z′1~Z′N. In an embodiment, the second encoder 9206 may be configured as an artificial intelligence AI model. The first encoder 9206 may be trained to receive and encode first to Pth angle difference information A1~AP through machine learning.

After learning is completed, the second encoder 9206 may reduce feedback overhead by encoding and outputting channel information. The error compensation circuit 9207 may receive a latent vector zₜ₋₁ at time t−1 immediately before the current time t from the first encoder 9204, and may receive a quantized latent vector z_{q,t-1} at time t−1 from the first vector quantization circuit 9205. The error compensation circuit 9207 may compensate the first′ to Nth′ latent vectors Z′1 to Z′N based on the latent vector zₜ₋₁ and the quantized latent vector z_{q,t-1} to generate the first″ to Nth″ latent vectors Z″1~Z″N. The error compensation circuit 9207 may transfer the first″ to Nth″ latent vectors Z″1~Z″N to the second vector quantization circuit 9208. In an embodiment, the error compensation circuit 9207 may compensate for an error between a compressed latent vector based on angle difference information at the current time point t and a compressed latent vector based on angle difference information at the previous time point t−1. The method of generating a latent vector based on the angle difference may reconstruct by adding the newly received angle difference information to the previous angle information, so the reconstruction error occurring in the previous feedback may be propagated to the current reconstruction process. To mitigate this error propagation phenomenon, the error compensation circuit 9207 may add the error vector at the previous time point t−1 to the angle difference information at the current time point t.

For example, the error vector may be represented by equation 24.

z_{r,t-1}=zₜ₋₁−z_{q,t-1} Equation 24

Here, z_{r,t-1} may be the error vector at the previous time t−1. The error vector may be the difference between the latent vector zₜ₋₁ at the previous time t−1 and the quantized value z_{q,t-1} of that latent vector.

The error compensation circuit 9207 may add an error vector to the first′ to N′-th latent vectors Z′1~Z′N which are the outputs of the second encoder 9206 to generate the first″ to N″ latent vectors Z″1~Z″N.

Accordingly, the inputs of the first vector quantization circuit 9205 and the second vector quantization circuit 9208 at time t may be represented by equation 25.

$${z}_{t} = \{ \begin{matrix}{f}_{enc 1} ( {Φ}_{t} ) , & if {I}_{t} = 0 \\ {f}_{enc 2} ( {h}^{′} ( {Φ}_{t}^{diff} ) ) + {z}_{r , t - 1} , & else if {I}_{t} = 1\end{matrix} \qquad Equation 25$$

The second vector quantization circuit 9208 may divide the first″ to Nth″ latent vectors Z″1 to Z″N into N sub-vectors of dimension D. Thereafter, the second vector quantization circuit 9208 may individually quantize each sub-vector Z″ᵢ (i is an integer from 1 to N). In an embodiment, the second vector quantization circuit 9208 may individually quantize each of the N sub-vectors using a codebook of dimension D to generate quantized sub-vectors z″_{g,1}~z″_{g,N}. For example, the second vector quantization circuit 9208 may select a value closest to each sub-vector from among the values stored in the codebook using the minimum Euclidean distance criterion, and quantize each sub-vector using the selected value.

The beamforming feedback generator 920 may generate second feedback information BF_FB2 by combining quantized sub-vectors z_{q,1}~z_{q,N} or quantized sub-vectors z″_{q,1}~z″_{q,N-1} based on the value of the indicator variable Iₜ. Additionally, the beamforming feedback generator 920 may generate a feedback indicator FI that indicates whether the second feedback information BF_FB2 includes a quantized sub-vector z_{q,1}~z_{q,N} or a quantized sub-vector z″_{q,1}~z″_{q,N}. In an embodiment, the beamforming feedback generator 920 may generate a feedback indicator FI based on the value of the indicator variable Iₜ. A feedback indicator FI may indicate information about a sub-vector that the feedback information contains. For example, a feedback indicator FI may indicate whether the feedback information includes angular information or angular difference information. For example, when the feedback indicator FI is 1, the second feedback information BF_FB2 may include a quantized sub-vector z″_{g,1}~z″_{q,N}, and when the feedback indicator FI is 0, the second feedback information BF_FB2 may include a quantized sub-vector z_{q,1}~z_{q,N}.

The beamforming feedback generator 920 may transmit second feedback information BF_FB2 and a feedback indicator FI to the beamformer 200.

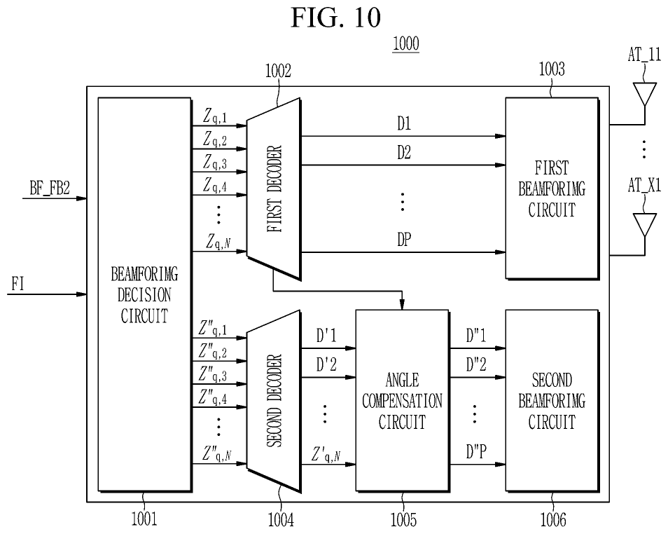

FIG. 10 is a drawing specifically illustrating a beamformer according to an embodiment.

As illustrated in FIG. 10, the beamformer 1000 may include a beamforming decision circuit 1001, a first decoder 1002, a first beamforming circuit 1003, a second decoder 1004, an angle compensation circuit 1005, and a second beamforming circuit 1006.

The beamforming decision circuit 1001 may receive second feedback information BF_FB2 and a feedback indicator FI from the beamformer 90 of FIG. 9. The beamforming decision circuit 100 may determine whether the second feedback information BF_FB2 includes a quantized sub-vector z_{q,1}~z_{q,N} or a quantized sub-vector z″_{q,1}~z″_{q,N} based on the feedback indicator FI, and may transmit the information to a corresponding decoder among the corresponding first decoder 1002 and the second decoder 1004. For example, when the feedback indicator FI is 1, the beamforming decision circuit 1001 may transmit the quantized sub-vector z_{q,1}~z_{q,N} in the second feedback information BF_FB2 to the first decoder 1002. For example, when the feedback indicator FI is 0, the beamforming decision circuit 1001 may transmit the quantized sub-vector z″_{q,1}~z″g, in the second feedback information BF_FB2 to the second decoder 1004.

The first decoder 1002 may decode the sub-vectors z_{q,1}~z_{q,N} included in the second feedback information BF_FB2 and provide N decoded angle information D0~DP to the first beamforming circuit 1003. The first decoder 1002 may be configured to decode the sub-vectors z_{q,1}~z_{q,N} included in the second feedback information BF_FB2 received from the beamformer 90. At this time, the encoded channel information z_{q,1}~z_{q,N} may be quantized information in the beamformer 90.

Like the first encoder 9204, the first decoder 1002 may also be trained to decode channel information, which is input data input to the first decoder 1002, through machine learning. The first decoder 1002 that has completed training may output P decoded angle information D1~DP by decoding the channel information fed back from the beamformer side as it was originally.

Referring again to FIG. 10, the first beamforming circuit 1003 may perform beamforming based on decoded angle information D1~DP.

The first encoder 9204 and the first vector quantization circuit 9205 of FIG. 9, and the first decoder 1002 of FIG. 10 may be learned together based on equation 26.

[symbol]

=d(Φ,\hat{Φ})+∥sg(z)−z_{q}∥²+β∥z−sg(z_{q})∥² Equation 26

Here, d(·,·) is an arbitrary distortion index, and the difference between two input values may be measured using a specific criterion. For example, the mean squared error MSE as

$$d ( Φ , \hat{Φ} ) = {‖ Φ - \hat{Φ} ‖}_{F}^{2}$$

is used, but the present invention is not limited thereto and any distortion index may be used. Additionally, sg(·) may represent a stop-gradient operator that ignores gradient computation. Additionally, ∥sg(z)−z_{q}∥²+β∥z−sg(z_{q})∥² is to minimize the difference between z and z_{q} depending on quantization loss. Quantization loss may be computed by two terms and hyperparameters β.

The second decoder 1004 may decode the sub-vectors z″_{q,1}~z″_{q,N} included in the second feedback information BF_FB2 and provide N decoded angle difference information D′1 to D′P to the angle compensation circuit 1005.

The second decoder 1004 may be configured to decode the sub-vectors z″_{q,1}~z″_{q,N} included in the second feedback information BF_FB2 received from the beamformer 90. At this time, the encoded channel information z″_{q,1}~z″_{q,N} may be quantized information in the beamformer 90.

Like the second encoder 9206, the second decoder 1004 may also be trained to decode channel information, which is input data input to the second decoder 1004, through machine learning. The second decoder 1004 that has completed training may output P decoded angle difference information D′1~D′P by decoding the channel information fed back from the beamformer side as it was originally.

The angle compensation circuit 1005 may reflect previous angle information into the decoded angle difference information D′1~D′P to generate a compensated decoder output D″1~D″P. In an embodiment, the angle compensation circuit 1005 may generate compensated decoder outputs D″1~D″P by reflecting decoded angle difference information D′1~D′P and angles corresponding to the angle difference information D′1~D′P. The angle compensation circuit 1005 may transmit the compensated decoder output D″1~D″P to the second beamforming circuit 1006.

The values input to the first beamforming circuit 1003 and the second beamforming circuit 1006 may be represented by equation 27.

$${\hat{Φ}}_{t} = \{ \begin{matrix}{f}_{dec 1} ( {z}_{q , t} ) , & if {I}_{t} = 0 \\ {f}_{dec 2} ( {z}_{q , t} ) + {\hat{Φ}}_{t - 1} , & else if {I}_{t} = 1\end{matrix} \qquad Equation 27$$

The second encoder 9206, the error compensation circuit 9207, and the second vector quantization circuit 9208 of FIG. 9, the second decoder 1004 and the angle compensation circuit 1005 of FIG. 10, may be trained together based on equation 28.

[symbol]

=d(Φ,\hat{Φ})+∥sg(z)−z_{q}∥²+β∥z−sg(z_{q})∥² Equation 28

Here, d(·,·) is an arbitrary distortion index, and the difference between two input values may be measured using a specific criterion. For example, the mean squared error MSE as

$$d ( Φ , \hat{Φ} ) = {‖ Φ - \hat{Φ} ‖}_{F}^{2}$$

is used, but the present invention is not limited thereto and any distortion index may be used. Additionally, sg(·) may be stop-gradient operators that z and z_{q} may suppress gradient computation during the backpropagation process. Additionally, ∥sg(z)−z_{q}∥²+β∥z−sg(z_{q})∥² may be a term to minimize the difference between z and z_{q} depending on the quantization loss. Quantization loss may be computed by two terms and hyperparameters β.

The second beamforming circuit 1006 may perform beamforming based on the compensated decoder outputs D″1 to D″P.

Meanwhile, the first encoder 9204, the second encoder 9206, the first vector quantization circuit 9205, the error compensation circuit 9207, and the second vector quantization circuit 9208 of FIG. 9, and the first decoder 1002, the second decoder 1004, and the angle compensation circuit 1005 of FIG. 10 may be learned together based on equation 29.

$${ℒ}_{advq} = {‖ Exp ( j {Φ}_{t} ) - Exp ( j {\hat{Φ}}_{t} ) ‖}_{F}^{2} + {‖ sg ( {z}_{t} ) - {z}_{q , t} ‖}^{2} + β {‖ {z}_{t} - sg ( {z}_{q , t} ) ‖}^{2} \qquad Equation 29$$

Here, Exp(·) is a function that outputs a matrix by applying a function exp(·) to each element of the input matrix. Accordingly, the beamformer 1000 may reflect the periodicity and temporal correlation of the angular parameters of the wireless communication system 20. The distortion indicator may be selected as

$$d ( Φ , \hat{Φ} ) = {‖ Exp ( j Φ ) - Exp ( j \hat{Φ} ) ‖}_{F}^{2} .$$

The distortion index may ensure the shortest path that minimizes the difference between the model output and the actual value, similar to the principle of the preprocessing process described above.

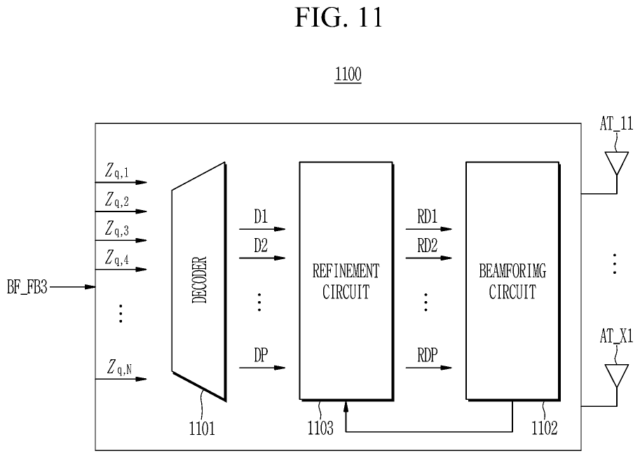

FIG. 11 is a drawing specifically illustrating a beamformer according to an embodiment.

As illustrated in FIG. 11, the beamformer 1100 may include a decoder 1101, a refinement circuit 1103, and a beamforming circuit 1102.

The decoder 1101 may decode the sub-vectors z_{q,1}~z_{q,N} included in the third feedback information BF_FB3 and provide N decoded angle information D1~DP to the beamforming circuit 702.

The decoder 1101 may be configured to decode N encoded channel information z_{q,1}~z_{q,N} included in the third feedback information BF_FB3 received from the beamformee 100 of FIG. 3. At this time, the encoded channel information~ may be quantized information in the beamformee 100.

The refinement circuit 1103 may refine the angle information D1~DP based on the fact that the wireless communication system has temporally correlated channels. For example, the refinement circuit 1103 may refine the current angle information using a preset number T of angle information based on the current time t. The refinement circuit 1103 may generate refined angle information RD1 to RDP. The operation of the refinement circuit 1103 may be represented by the equation 30 below.

f_{refine}(\hat{Φ}_{t-T+1}, . . . ,\hat{Φ}ₜ₋₁,\hat{Φ}ₜ)=Φ̌ₜ Equation 30

Here, f_{refine} represents the function of the refinement circuit 1103, and Φ̌ₜ represents the angle information refined at time t. As shown in equation 29, the refinement circuit 1103 may generate refined angle information RD1~RDP by also considering the current angle \hat{Φ}ₜ.

Meanwhile, the refinement circuit 1103 may be trained separately from the encoder in the beamformer corresponding to the decoder 1101 and the beamformer 1100. In an embodiment, training for the refinement circuit 1103 may be performed after completing training of the encoder in the beamformer corresponding to the decoder 1101 and beamformer 1100.

The refinement circuit 1103 may be trained based on equation 31.

$${ℒ}_{refine} = {‖ Exp ( j {Φ}_{t} ) - Exp ( j {\check{Φ}}_{t} ) ‖}_{F}^{2} \qquad Equation 31$$

At this time, for the training of the refinement circuit 1103, the output of a decoder may be used, wherein the decoder 110 has already been jointly trained with a corresponding encoder. The loss function [symbol] may reflect the temporal correlation and periodicity of angular information.

The beamformer 1100 may determine whether to use the refinement circuit 1103 based on time domain channel selectivity. In an embodiment, the refinement circuit 1103 may use recursive refinement, reusing the refined angles Φ̌ₜ. This may be represented by the equation 32 below.

$${\check{Φ}}_{t} = \{ \begin{matrix}{f}_{ref} ( {\check{Φ}}_{t - T + 1} , … , {\check{Φ}}_{t - 1} , {\hat{Φ}}_{t} ) , & if t \geq 2 T - 1 \\ {f}_{ref} ( {\hat{Φ}}_{t - T + 1} , … , {\hat{Φ}}_{T - 1} , {\check{Φ}}_{T} , … , {\check{Φ}}_{t - 1} , {\hat{Φ}}_{t} ) , & otherwise\end{matrix} \qquad Equation 32$$

As shown in Equation 32, in the initial section, the refinement circuit 1103 learns based on Equations 30 and 31, and from the point in time t>T, it may learn based on Equations 31 and 32.

The refinement circuit 1103 may transmit refined angle information RD1~RDP to the beamforming circuit 1102.

The beamforming circuit 1102 may perform beamforming based on refined angle information RD1~RDP.

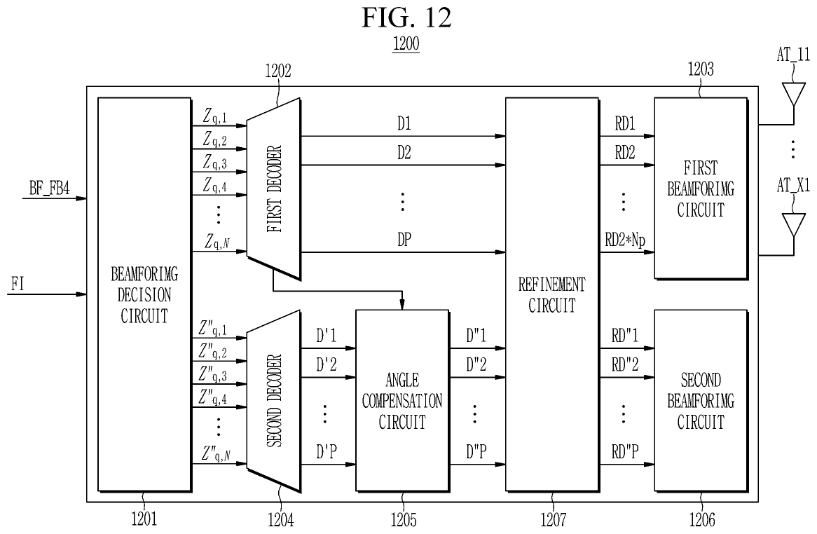

FIG. 12 is a drawing specifically illustrating a beamformer according to an embodiment.

As illustrated in FIG. 12, the beamformer 1200 may include a beamforming decision circuit 1201, a first decoder 1202, a first beamforming circuit 1203, a second decoder 1204, an angle compensation circuit 1205, a second beamforming circuit 1206, and a refinement circuit 1207.

Unless otherwise stated, the description of each of the beamforming decision circuit 1001, the first decoder 1002, the first beamforming circuit 1003, the second decoder 1004, the angle compensation circuit 1005, and the second beamforming circuit 1006 described with reference to FIG. 10 may also be applied to each of the beamforming decision circuit 1201, the first decoder 1202, the first beamforming circuit 1203, the second decoder 1204, the angle compensation circuit 1205, and the second beamforming circuit 1206.

The refinement circuit 1207 may receive decoded angle information D1~DP from the first decoder 1202 and compensated decoder output D″1~D″P from the angle compensation circuit 1205. The refinement circuit 1207 may refine angle information based on the decoded angle information D1~DP and the compensated decoder output D″1~D″P. For example, if the fourth feedback information BF_FB4 includes a quantized sub-vector z_{q,1}~z_{q,N} based on the feedback indicator FI, the refinement circuit 1207 may generate refined angle information RD1~RDP based on the decoded angle information D1~DP according to equations 30 to 32. For example, if the fourth feedback information BF_FB4 includes a quantized sub-vector z″_{q,1}~z″_{q,N} based on the feedback indicator FI, the refinement circuit 1207 may generate refined angle information RD″1~RD″P based on the compensated angle information D″1~D″P according to equations 30 to 32.

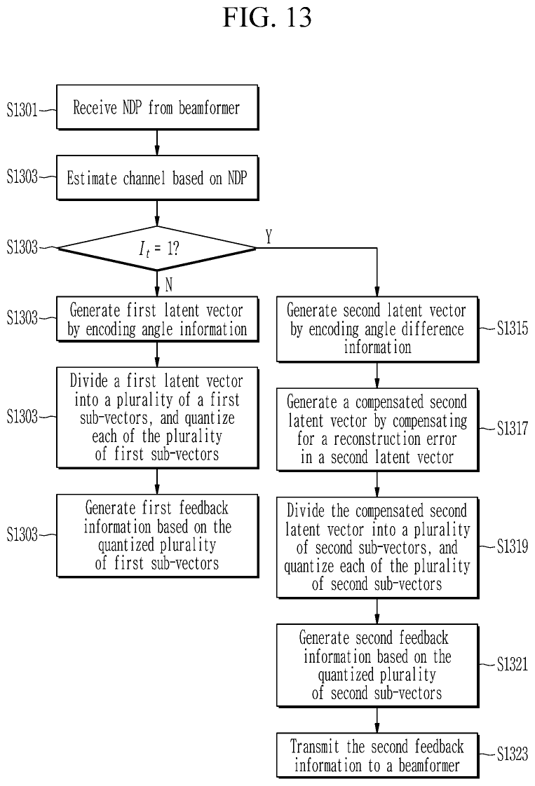

FIG. 13 is a diagram illustrating an operation method of a wireless communication system according to an embodiment. Specifically, FIG. 13 is a drawing showing the operation of the beamformer 90 according to FIG. 9.

First, the beamformer 90 may receive NDP from the beamformer 1000 in operation S1301.

Beamformer 90 may estimate the channel based on NDP S1303.

Beamformer 90 may determine whether the indicator variable Iₜ is 1 in operation S1305.

The indicator variable Iₜ may be a function to determine whether the difference in the angular parameters is sparse.

In an embodiment, the beamformer 90 may derive the plurality of angle information based on the estimated channel information. Thereafter, the beamformer 90 may derive the plurality of angle difference information based on the plurality of angle information and perform preprocessing on the plurality of angle difference information. Beamformer 90 may determine whether the preprocessed angle difference is less than a preset threshold based on equations 21 to 23.

If the indicator variable Iₜ is not 1, the beamformer 90 may encode angle information to generate a first latent vector in operation S1307.

Thereafter, the beamformer 90 may divide the first latent vector into a plurality of first sub-vectors and quantize each of the plurality of first sub-vectors in operation S1309.

In an embodiment, the beamformer 90 may individually quantize each of the plurality of first sub-vectors using a codebook. In an embodiment, the codebook size may be set based on the training results of the beamformer 1000 and the beamformer 90.

Beamformer 90 may generate first feedback information based on a plurality of quantized first sub-vectors in operation S1311.

The beamformer 90 may transmit the first feedback information to the beamformer 200 in operation S1313.

When the indicator variable Iₜ is 1, the beamformer 90 encodes angle difference information to generate a second latent vector in operation S1315.

Thereafter, the beamformer 90 may compensate for the reconstruction error in the second latent vector to generate a compensated second latent vector in operation S1317.

In an embodiment, the beamformer 90 may compensate for the error between the compressed latent vector based on the angle difference information at the current time point t and the compressed latent vector based on the angle difference information at the previous time point t−1. For example, the beamformer 90 may compensate for the reconstruction error of the second latent vector based on equation 24 and generate a compensated second latent vector.

The beamformer 90 may divide the compensated second latent vector into the plurality of second sub-vectors and quantize each of the plurality of second sub-vectors in operation S1319.

In an embodiment, the beamformer 90 may individually quantize each of the plurality of second sub-vectors using a codebook. In an embodiment, the codebook size may be set based on the training results of the beamformer 1000 and the beamformer 90.

Beamformer 90 may generate second feedback information based on a plurality of quantized second sub-vectors in operation S1321.

The beamformer 90 may transmit the second feedback information to the beamformer in operation S1323.

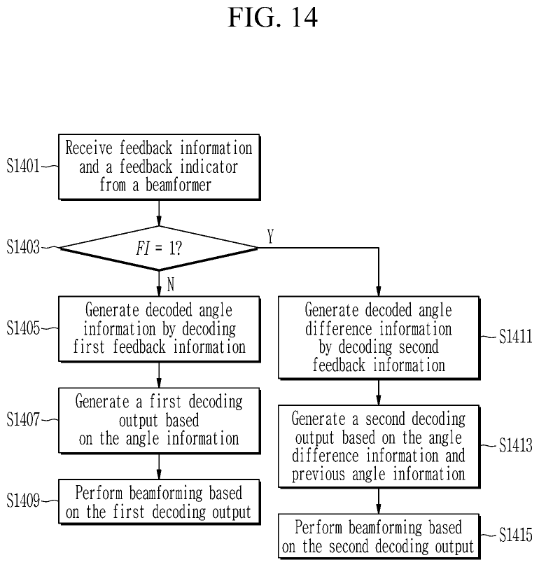

FIG. 14 is a diagram illustrating an operation method of a wireless communication system according to an embodiment. Specifically, FIG. 14 is a drawing showing the operation of a beamformer 1000 according to FIG. 10.

The beamformer 1000 may receive feedback information and a feedback indicator FI from the beamformee 100 in operation S1401.

In an embodiment, a feedback indicator FI may indicate information about a sub-vector that the feedback information contains. For example, a feedback indicator FI may indicate whether the feedback information contains angular information or angular difference information.

The beamformer 1000 may determine whether the feedback indicator FI is 1 in operation S1403.

If the feedback indicator FI is not 1, the beamformer 1000 may decode the first feedback information to generate decoded angle information in operation S1405.

The beamformer 1000 may generate a first decoding output based on the angle information in operation S1407.

The beamformer 1000 may perform beamforming based on the first decoding output in operation S1409.

When the feedback indicator FI is 1, the beamformer 1000 may decode the second feedback information to generate decoded angle difference information in operation S1411.

The beamformer 1000 may generate a second decoding output based on the angle difference information and the previous angle information in operation S1413.

The beamformer 1000 may generate a compensated decoder output by reflecting the decoded angle difference information and the angle corresponding to the angle difference information. For example, the beamformer 1000 may generate a compensated decoder output as a second decoding output by reflecting the previous angle into the decoded angle difference information.

The beamformer 1000 may perform beamforming based on the second decoding output in operation S1415.

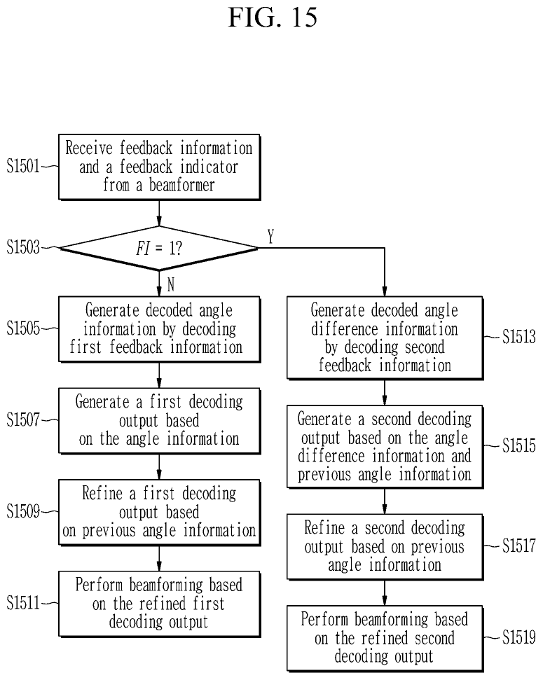

FIG. 15 is a diagram illustrating an operation method of a wireless communication system according to an embodiment. Specifically, FIG. 15 is a drawing showing the operation of a beamformer 1200 according to FIG. 12.

The beamformer 1200 may receive feedback information and a feedback indicator FI from the beamformee 100 in operation S1501.

In an embodiment, a feedback indicator FI may indicate information about a sub-vector that the feedback information contains. For example, a feedback indicator FI may indicate whether the feedback information contains angular information or angular difference information.

The beamformer 1200 may determine whether the feedback indicator FI is 1 in operation S1503.

When the feedback indicator FI is not 1, the beamformer 1200 may decode the first feedback information to generate decoded angle information in operation S1505.

The beamformer 1200 may generate a first decoding output based on the angle information in operation S1507.

The beamformer 1200 refines the first decoding output based on the previous angle information in operation S1509.

In an embodiment, the beamformer 1200 may refine the first decoding output using a preset number T of angle information based on the current time t. For example, the beamformer 1200 may refine the first decoding output based on equations 30 to 32.

The beamformer 1200 may perform beamforming based on the refined first decoding output in operation S1511.

When the feedback indicator FI is 1, the beamformer 1200 may decode the second feedback information to generate decoded angle difference information in operation S1513.

The beamformer 1200 may generate a second decoding output based on the angle difference information and the previous angle information in operation S1515.

The beamformer 1200 may generate a compensated decoder output by reflecting the decoded angle difference information and the angle corresponding to the angle difference information. For example, the beamformer 1200 may generate a compensated decoder output as a second decoding output by reflecting the previous angle into the decoded angle difference information.

The beamformer 1200 may refine the second decoding output based on the previous angle information in operation S1517.

In an embodiment, the beamformer 1200 may refine the second decoding output using a preset number T of angle information based on the current time t. For example, the beamformer 1200 may refine the second decoding output based on equations 30 to 32.

The beamformer 1200 may perform beamforming based on the refined second decoding output in operation S1519.

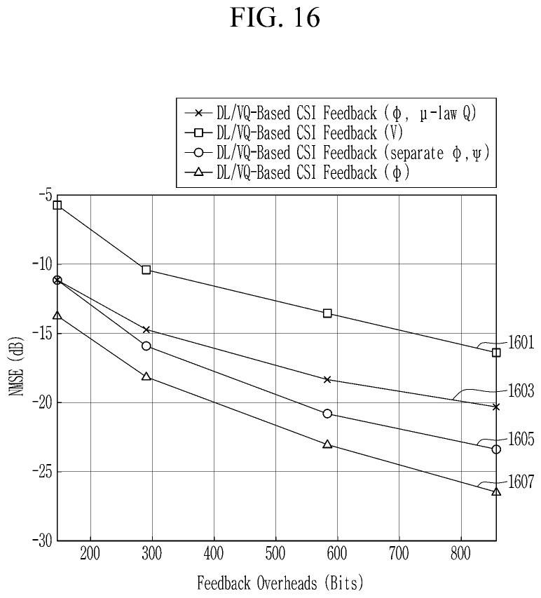

FIG. 16 is a graph showing the normalized mean squared error NMSE according to feedback overhead.

As illustrated in FIG. 16, the first graph 1601, the second graph 1603, the third graph 1605, and the fourth graph 1607 illustrate NMSE according to feedback overhead.

Here, the Y-axis is

$$NMSE = 𝔼 \{ {‖ \overline{V} - \hat{V} ‖}_{F}^{2} / {‖ \overline{V} ‖}_{F}^{2} \} ,$$

V̅ is the input input to the beamformee 100, and \hat{V} means the matrix reconstructed by the beamformer 200 based on the feedback information transmitted to the beamformer 200 in response to the beamformee 100 receiving V̅.

First, the first graph 1601 is a graph showing NSME when the beamformer and beamformee beamforming on V̅ according to a conventional method.

The third graph 1605 is a graph showing NSME when the beamformee separates the angle information, ψ, φ into separate parameters and beamforms V̅.

The second graph 1603 and the fourth graph 1607 are graphs representing NSME when the beamformer 200 and the beamformee 100 according to an embodiment beamforming on V̅ using angle information ψ, φ as one parameter, angle information Φ. The second graph 1603 represents NSME when the μ-law quantization technique among scalar quantization techniques is used, and the fourth graph 1607 represents NSME when the vector quantization technique is used.

As illustrated in FIG. 16, when using a wireless communication system 10 according to an embodiment, a lower NSME value may be achieved even when less feedback overhead is used compared to a conventional case.

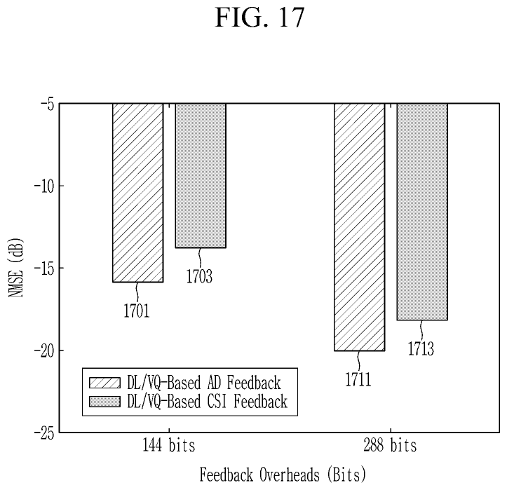

FIG. 17 is a graph illustrating NSME according to feedback overhead.

The first graph 1701 is a graph representing NSME when a beamformer 200 and a beamformee 100 according to an embodiment beamforming on V̅ with considering the periodicity of the angle difference when the feedback overhead is 144 bits.

The second graph 1703 is a graph showing NSME when the beamformer 200 and the beamformee 100 according to an embodiment beamforming on V̅ without considering the periodicity of the angle difference when the feedback overhead is 144 bits.

The third graph 1711 is a graph showing NSME when the beamformer 200 and the beamformee 100 according to an embodiment perform beamforming V̅ while considering the periodicity of the angle difference when the feedback overhead is 288 bits.

The fourth graph 1713 is a graph showing NSME when the beamformer 200 and the beamformee 100 according to an embodiment beamforming on V̅ without considering the periodicity of the angle difference when the feedback overhead is 144 bits.

For example, the first graph 1701 and the second graph 1703 are graphs showing a case where beamforming is performed on V̅ using a beamformer 90 according to FIG. 9 and a beamformer 1000 according to FIG. 10.

For example, the third graph 1711 and the fourth graph 1713 are graphs showing a case where beamforming is performed on V̅ using a beamformer 40 according to FIG. 4 and a beamformer 70 according to FIG. 7. As shown, when the size of the same feedback overhead is taken into account, the case where the periodicity of the angle difference is taken into account may have a lower NSME than the case where the periodicity of the angle difference is not taken into account.

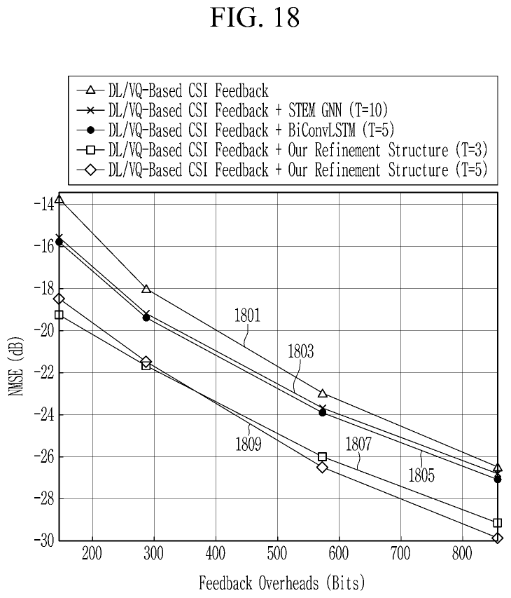

FIG. 18 is a graph illustrating NSME according to feedback overhead.

The first graph 1801 is a graph showing NSME when a beamformer 200 and a beamformee 100 according to an embodiment beamforming on V̅ without using a CSI refinement technique.

The second graph 1803 and the third graph 1805 are graphs showing NSME when a beamformer and a beamformer according to an embodiment beamforming on V̅ using a conventional refinement technique. For example, the second graph 1803 is a graph showing a case where beamforming is performed on V̅ using the STEM GNN [4] technique. In addition, the third graph 1805 is a graph showing the case where beamforming is performed on V̅ using the BiConvLS™[5] technique.

The fourth graph 1807 and the fifth graph 1809 are graphs showing NSME when a beamformer 200 according to an embodiment beamforms V̅ while using a refinement technique according to an embodiment. For example, the fourth graph 1807 and the fifth graph 1809 are graphs showing a case where beamforming is performed on V̅ using a beamformer 1200 according to FIG. 12.

The fourth graph 1807 shows a case where the current angle information is refined using three pieces of angle information based on the current time t, and the fifth graph 1809 shows a case where the current angle information is refined using a preset number of five pieces of angle information based on the current time t.

As illustrated in FIG. 18, when having the same feedback overhead size, the case where refinement is performed based on current angle information and previous angle information may have a relatively lower NSME than the case where refinement is not performed.

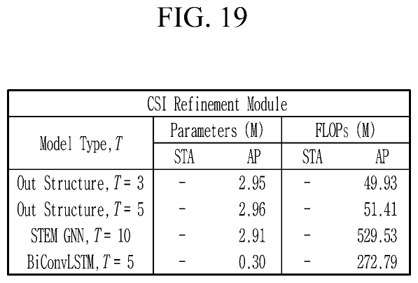

FIG. 19 is a table showing the complexity of the beamformer structure according to FIG. 18.

The computational complexity of artificial neural network structures may be represented by the number of configuration parameters included in each structure and the floating point operations per second FLOPs.

As illustrated in FIG. 19, the case of beamforming V̅ using a refinement circuit (1103 of FIG. 11, 1207 of FIG. 12) according to an embodiment may have a relatively lower computational complexity in terms of both the number of configuration parameters and FLOPs compared to the case of beamforming V̅ using the STEM GNN [4] technique and the case of beamforming V̅ using the BiConvLS™ [5] technique.

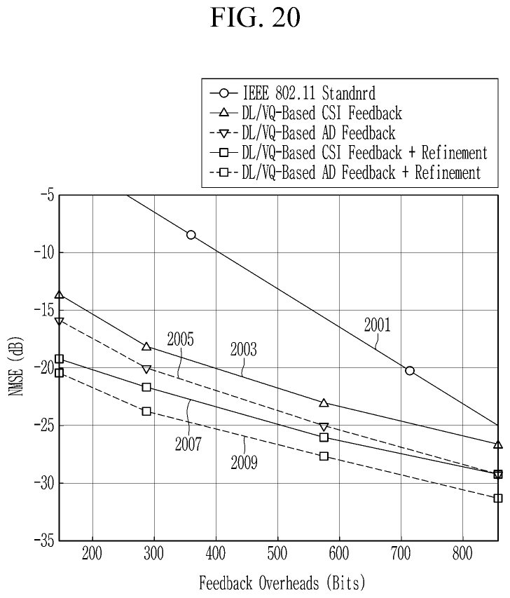

FIG. 20 is a graph illustrating NSME according to feedback overhead.

The first graph 2001 is a graph showing the case of beamforming V̅ according to the IEEE.802.11 standard.

The second graph 2003 is a graph showing NSME when a beamformer 200 and a beamformee 100 beamforming on V̅ according to an embodiment.

The third graph 2005 is a graph showing NSME when a beamformer 200 and a beamformee 100 according to an embodiment of the present invention beamforming on V̅ a periodicity of an angular difference.

The fourth graph 2007 is a graph showing NSME when a beamformer 200 and a beamformee 100 according to an embodiment beamforming on V̅ while using a refinement technique according to an embodiment. For example, the fourth graph 1807 is a graph showing a case in which beamforming is performed on V̅ using a beamformer 1100 according to FIG. 11.

The fifth graph 2009 is a graph showing NSME when a beamformer 200 and a beamformee 100 according to an embodiment reflect the periodicity of the angular difference and beamforming on V̅ while using a refinement technique according to an embodiment. For example, the fourth graph 1807 is a graph showing a case in which beamforming is performed on V̅ using a beamformer 1200 according to FIG. 12.

As illustrated in FIG. 20, when beamforming is performed on V̅ by a beamformer 200 and a beamformee 100 according to an embodiment of the present invention, lower NMSE performance per size of the same feedback overhead may be achieved compared to when beamforming is performed on V̅ according to the IEEE.802.11 standard.

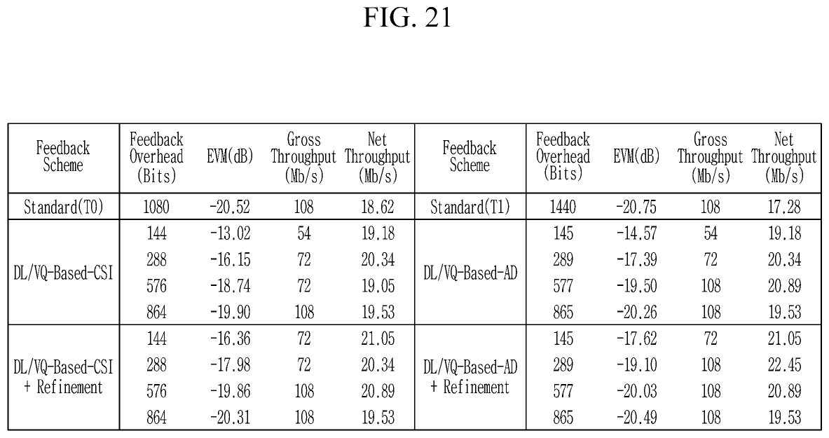

FIG. 21 is a table showing the net throughput of a wireless communication system according to a prior art and an embodiment.

Specifically, FIG. 21 shows a comparison of net throughput performance between deep learning and vector quantization-based feedback techniques and conventional techniques.

As shown in FIG. 21, when the beamformer 200 and the beamformee 100 beamforming on V̅ (DL/VQ-Based CSI Feedback), when the beamformer 200 and the beamformee 100 beamforming on V̅ (DL/VQ-Based AD Feedback) reflecting the periodicity of the angular difference, when the beamformer 200 and the beamformee 100 beamforming on V̅ (DL/VQ-Based CSI Feedback+Refinement) using a refinement technique according to an embodiment, when the beamformer 200 and the beamformee 100 beamforming on V̅ (DL/VQ-Based AD Feedback+Refinement) reflecting the periodicity of the angular difference and using a refinement technique according to an embodiment, it may be confirmed that the throughput performance is improved more than that of the conventional standard.

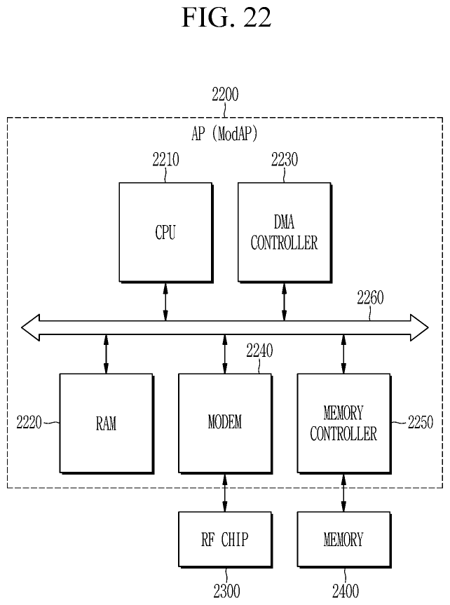

FIG. 22 is a block diagram illustrating an application processor according to an embodiment.

Referring to FIG. 22, the application processor 2200 may be referred to as ModAP as the function of a modem is integrated therein.

The application processor 2200 may be implemented as a system on chip SoC and may include a CPU 2210, RAM 2220, DMA controller 2230, modem 2240, and memory controller 2250. In addition, the application processor 2200 may further include other components, such as a power management unit, a display controller, sensors, etc. Components of a system on chip SoC may transmit and receive data via a bus 2260.

The CPU 2210 may control the overall operation of the application processor 2200. The CPU 2210 may control the operation of the components of the application processor 2200 by processing or executing programs and/or data stored in the RAM 2220 (or ROM). In an embodiment, the CPU 2210 may be implemented as a multi-core. Multi-core is a computing component that has two or more independent cores.

RAM 2220 may temporarily store programs (e.g., operating system, application programs), data, or instructions. For example, programs and/or data stored in the memory 2400 may be temporarily stored in the RAM 2220 according to the control or booting code of the CPU 2210. RAM 2220 may be implemented as DRAM or SRAM.

The DMA controller 2230 supports data transfer between components of the application processor 2200 and may control data transfer so that it may occur directly between components without intervention of the CPU 2210.

The modem 2240 may modulate data to be transmitted to suit the wireless environment for wireless communication and recover received data. The modem 2240 may correspond to the AP AP1, AP2 of FIGS. 1 and 2 and the beamformer 200, 70, 1000, 1100, 1200 of FIGS. 3 to 15.

The beamformer 200 may receive feedback information and a feedback indicator from the beamformee 100, detect information included in the feedback information based on the feedback indicator, and perform decoding on angle information and/or angle difference information to generate a decoding output.

The beamformer 200 may compensate for the decoding output based on the angle difference information and the previous angle information, and then refine the decoding output based on the angle information of the current time and the previous time point. Accordingly, the beamformer 200 may improve the performance of communication operations.

The RF chip 2300 may convert an RF signal, which is a high-frequency signal received through an antenna, into a baseband signal, which is a low-frequency signal, and transmit the converted baseband signal to a modem 2240. Additionally, the RF chip 2300 may convert a baseband signal received from a modem 2240 into a high frequency signal and transmit the RF signal to a wireless network through an antenna. Additionally, the RF chip 2300 may amplify or filter the signal.

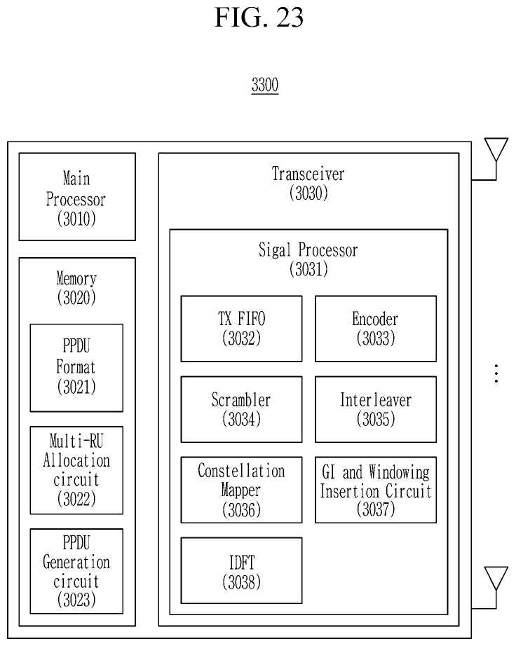

FIG. 23 is a block diagram of a wireless communication device according to an embodiment.

Referring to FIG. 23, a wireless communication device 3000 may be a transmitting device (e.g., an access point AP) or a receiving device (e.g., a station STA) including a transceiver capable of data communication. That is, the wireless communication device 3000 of FIG. 23 may be any one of the access points AP1, AP2 and stations (STA1, STA2, STA3, STA4) illustrated in FIG. 1, and may be applied to, for example, a computer, a smart phone, a portable electronic device, a tablet, a wearable device, a sensor used in the Internet of Things IoT, etc. Below, an example will be described in which the wireless communication device 3000 is a transmitting device.

A wireless communication device 3000 may include a main processor 3010, a memory 3020, a transceiver 3030, and an antenna array. The main processor 3010, memory 3020, transceiver 3030 and antenna array may be directly or indirectly connected to each other. A wireless communication device 3000 may include one or more main processors 3010, memory 3020, and a transceiver 3030.

The main processor 3010 may be electrically connected to the transceiver. The main processor 3010 may control the memory 3020 and the transceiver 3030.

A main processor 3010 according to an embodiment may execute one or more instructions stored in a memory to receive a sounding NDP from an access point through a transceiver, estimate channel information based on the sounding NDP, obtain angle information by performing singular value decomposition on the estimated channel, and obtain a latent vector by encoding the angle information. The main processor 3010 may divide a latent vector into the plurality of sub-vectors, and vector quantize each of the plurality of sub-vectors to reflect the periodicity of the angle difference, and feed it back to the access point through the transceiver. Accordingly, the wireless communication device 3000 may enable efficient and accurate communication even with a small feedback overhead.

The memory 3020 is electrically connected to the main processor and may store one or more instructions. Additionally, the memory 3020 may store PPDU format 3021 and bandwidth field information 3022. The transceiver 3030 may generate a PPDU using the PPDU format 3021 and bandwidth field information 3022 stored in the memory 3020. The transceiver 3030 may transmit the generated PPDU to an external receiving device (e.g., STA) via an antenna array.

Here, the memory 3020 may store a PPDU format 3021 including a signal field related format according to exemplary embodiments of the present application. Additionally, the memory 3020 may store processor-executable instructions that execute the RU allocation module 3022 and the PPDU generation module 3023. Processor-executable instructions stored in memory 3020 may be executed by the main processor 3010 or the signal processor 3031 included in the transceiver 3030.

For reference, the RU allocation module 3022 may use a RU allocation algorithm, method, or policy to allocate RUs to users (e.g., STAs) according to embodiments of the present application. And the PPDU generation module 3023 may generate signaling and indication related to RU allocation in the control field of the PPDU (i.e., also called a signaling field, and referred to as a signaling field hereinafter).

A memory 3020 according to an embodiment may store an encoder and/or decoder that are commonly configured for channel information, bandwidth, and/or grouping values. The memory 3020 may store training data for machine learning of the encoder and/or decoder.

A transceiver 3030 according to an embodiment may include a signal processor 3031. And the signal processor 3031 may have various modules (i.e., various modules of the transmit path) configured to generate each section of a PPDU or various types of communication transmission units.

Although FIG. 23 illustrates an embodiment in which a signal processor 3031 is included in a transceiver 3030, the present invention is not limited thereto, and the signal processor 3031 may be implemented as a separate configuration separate from the transceiver 3030.

Specifically, the signal processor 3031 may include a TX FIFO (Transmit First-In-First-Out) 3032 for sequentially storing and processing transmission data, an encoder 3033 for encoding data, a scrambler 3034 for randomly mixing data bit strings to improve error distribution performance, an interleaver 3035 for rearranging data to reduce interference between adjacent bits, a constellation mapper (a constellation mapper that may generate, for example, a QAM symbol) 3036, a guard interval and windowing insertion module 3037 for inserting a guard interval to reduce spectral interference and performing windowing processing to improve waveform characteristics of a signal, and an inversed discrete Fourier transformer IDFT 3038 for converting a frequency domain signal into a time domain signal.

For reference, the transceiver 3030 may include components well known to those skilled in the art as illustrated in the drawing. And these components may be implemented in a manner well known to those skilled in the art, and may be implemented using hardware, firmware, software logic, or a combination thereof.

When the wireless communication device 3000 is a receiving device, the transceiver 3030 illustrated in FIG. 23 may include components in a receiving path.

That is, when the wireless communication device 3000 is a receiving device, the transceiver 3030 may receive a PPDU including a preamble and a payload from the transmitting device. And the transceiver 3030 may decode the payload based on the preamble of the received PPDU. That is, the transceiver 3030 may identify an RU allocated to a receiving device by decoding a preamble of a PPDU through an internal decoder (not shown), and may decode a payload transmitted to the receiving device (i.e., a payload received from the transmitting device) based on the identified RU.

The subject of the decoding task may be a component other than the transceiver 3030 (e.g., the main processor 3010, etc.), but for the convenience of explanation, an example of decoding a payload based on the preamble of a PPDU received by the transceiver 3030 will be explained.

FIG. 23 only illustrates an example of a wireless communication device 3000, and the embodiment of the present application is not limited thereto.

That is, various changes may be made in FIG. 23.

Although the embodiments of the present invention have been described in detail above, the scope of the present invention is not limited thereto, and various modifications and improvements made by those skilled in the art using the basic concept of the present invention defined in the following claims also fall within the scope of the present invention.

What is claimed is:

1. A method of communication between a first device and a second device in a wireless communication system comprising the first device and the second device, the method being executed by at least one processor of the first device, and the method comprising:
receiving, from the second device, a Null Data Packet (NDP);
generating a plurality of channel information associated with a plurality of subcarriers based on the NDP;
generating a plurality of angle information based on the plurality of channel information;
encoding the plurality of angle information to generate a latent vector;
dividing the latent vector into N preset sub-vectors and vector-quantizing each of the N preset sub-vectors based on a codebook size; and
transmitting, to the second device, a beamforming feedback including N quantized sub-vectors.

2. The method of claim 1, wherein the generating the latent vector comprises:
generating a plurality of angle difference information based on two consecutive angle information among the plurality of angle information;
comparing a preprocessed angle difference with a preset threshold, wherein the preprocessed angle difference is based on the plurality of angle difference information and a preprocessing function; and
encoding the plurality of angle difference information to generate a first latent vector based on the preprocessed angle difference exceeding the preset threshold.

3. The method of claim 2,
wherein the preprocessing function is
$$h ( x ) = \{ \begin{matrix}x , & if \vert x \vert < π \\ - sgn ( x ) \times ( 2 π - \vert x \vert ) , & otherwise\end{matrix} ,$$
and
wherein sgn(·) is a function that returns a sign of an input value, and x is angle difference information.

4. The method of claim 2, wherein the generating the first latent vector comprises:
generating a compensated first latent vector based on a reconstruction error of the first latent vector, the reconstruction error being based on angle difference information at a first time point and an error vector at a second time point prior to the first time point,
wherein the error vector is a difference between a third latent vector at the second time point and a vector-quantized latent vector corresponding to the third latent vector.

5. The method of claim 2, further comprising
encoding the plurality of angle information to generate a second latent vector based on the preprocessed angle difference being less than or equal to the preset threshold.

6. The method of claim 2, wherein the preset threshold is set based on a number of channels between the first device and the second device.

7. The method of claim 2,
wherein the first device and the second device comprise respective neural networks, and the respective neural networks are trained by a loss function [symbol] ,
wherein
$${ℒ}_{advq} = {‖ Exp ( j {Φ}_{t} ) - Exp ( j {\hat{Φ}}_{t} ) ‖}_{F}^{2} + {‖ sg ( {z}_{t} ) - {z}_{q , t} ‖}^{2} + β {‖ {z}_{t} - sg ( {z}_{q , t} ) ‖}^{2} ,$$
and
wherein, zₜ is a latent vector at a first time point, z_{q,t} is a quantized latent vector at the first time point, Φₜ is angle information at the first time point, and \hat{Φ}ₜ is a value obtained by adding angle difference information \hat{Φ}ₜ₋₁ at a second time point before the first time point to the angle difference information at the first time point.

8. The method of claim 1,
wherein the first device and the second device comprise respective neural networks, and the respective neural networks are trained by a loss function [symbol] ,
wherein [symbol]
=d(Φ,\hat{Φ})+∥sg(z)−z_{q}∥²+β∥z−sg(z_{q})∥², and
wherein sg (·) is a stop-gradient operator that ignores gradient computation, d(·,·) is an arbitrary distortion index, z is a latent vector, and z_{q} is a quantized sub-vector.

9. A method of communication between a first device and a second device in a Wireless Local Area Network (WLAN) system comprising the first device and the second device, the method being executed by at least one processor of the second device, the method comprising:
receiving, from the first device, feedback information and a feedback indicator that indicates information about a sub-vector within the feedback information, and the feedback information comprising angle information;
determining whether the feedback indicator is 1;
based on determining that the feedback indicator is 1, decoding the angle information to generate a first decoding output;
beamforming based on the first decoding output.

10. The method of claim 9, wherein the feedback information further comprises angle difference information, and
wherein the method further comprises:
based on determining that the feedback indicator is not 1, decoding the angle difference information;
generating a second decoding output based on the angle difference information at a first time point and angle information at a second time point before the first time point among the decoded angle difference information; and
beamforming based on the second decoding output.

11. The method of claim 9, wherein the generating the first decoding output comprises:
refining the first decoding output, using a refinement circuit, based on angle information at a first time point and a plurality of angle information of a preset number before the first time point among the decoded angle information.

12. The method of claim 11,
wherein the refinement circuit is trained by a loss function [symbol] ,
wherein
$${ℒ}_{refine} = {‖ Exp ( j {Φ}_{t} ) - Exp ( j {\check{Φ}}_{t} ) ‖}_{F}^{2} ,$$
and
wherein Φₜ is the angle information at the first time point, and Φ̌ₜ is the refined angle information at the first time point.

13. A first device configured to communicate with a second device in a wireless communication system, the first device comprising:
a channel estimator configured to estimate a channels corresponding to a plurality of subcarriers based on a null data packet (NDP) received from the second device; and
a beamforming feedback generator configured to encode a plurality of channel information to:
generate a latent vector,
divide the latent vector into N preset sub-vectors,
vector-quantize each of the N preset sub-vectors based on a codebook size, and
generate beamforming feedback including the N quantized sub-vectors.

14. The first device of claim 13,
wherein the beamforming feedback generator comprises:
a feedback decision circuit configured to:
generate a plurality of angle difference information based on two consecutive angle information among a plurality of angle information, and
compare a preprocessed angle difference with a preset threshold based on the plurality of angle difference information and a preprocessing function; and
a first encoder configured to perform encoding on the plurality of angle information to generate a second latent vector based on the preprocessed angle difference being less than or equal to the preset threshold; and
a second encoder configured to encode the plurality of angle difference information to generate a first latent vector based on the preprocessed angle difference exceeding the preset threshold.

15. The first device of claim 14,
wherein the beamforming feedback generator further comprises:
an error compensation circuit configured to:
compensate for a reconstruction error of the first latent vector based on the angle difference information at a first time point and an error vector at a second time point before the first time point, and
generate a compensated first latent vector,
wherein the error vector is a difference between third latent vector at the second time point and a vector-quantized latent vector corresponding to the third latent vector.

16. The first device of claim 15,
wherein the codebook size is determined based on a training the first device and a training of the second device, and
wherein the beamforming feedback generator further comprises a first vector quantization circuit configured to vector-quantize the second latent vector into each of the N preset sub-vectors based on a minimum Euclidean distance criterion.

17. The first device of claim 16,
wherein the beamforming feedback generator further comprises a second vector quantization circuit configured to vector-quantize the compensated first latent vector into each of the N preset sub-vectors based on the minimum Euclidean distance criterion.

18. The first device of claim 14,
wherein the preprocessing function is
$$h ( x ) = \{ \begin{matrix}x , & if \vert x \vert < π \\ - sgn ( x ) \times ( 2 π - \vert x \vert ) , & otherwise\end{matrix} ,$$
and
wherein sgn(·) is a function that returns a sign of an input value, and x is angle difference information.

19. The first device of claim 14,
wherein the first device and the second device comprise respective neural networks, and the respective neural networks are trained by a loss function [symbol] ,
wherein [symbol]
=d(Φ,\hat{Φ})+∥sg(z)−z_{q}∥²+β∥z−sg(z_{q})∥², and
wherein sg(·) is a stop-gradient operator that ignores gradient computation, d(·,·) is an arbitrary distortion index, z is a latent vector, and z_{q} is a quantized sub-vector.

20. The first device of claim 14,
wherein the first device and the second device comprise respective neural networks, and the respective neural networks are trained by a loss function [symbol] ,
wherein
$${ℒ}_{advq} = {‖ Exp ( j {Φ}_{t} ) - Exp ( j {\hat{Φ}}_{t} ) ‖}_{F}^{2} + {‖ sg ( {z}_{t} ) - {z}_{q , t} ‖}^{2} + β {‖ {z}_{t} - sg ( {z}_{q , t} ) ‖}^{2} ,$$
and
wherein, zₜ is a latent vector at a first time point, z_{q,t} is a quantized latent vector at the first time point, Φₜ is angle information at the first time point, and \hat{Φ}ₜ is a value obtained by adding angle difference information \hat{Φ}ₜ₋₁ at a second time point before the first time point to the angle difference information at the first time point.
